(19) United States
(12) Patent Application Publication
(10) Pub. No.: US 2006/0061526 A1
(43) Pub. Date: Mar. 23, 2006

(54) Drive circuit and display apparatus

(75) Inventors: Tomoyuki Shirasaki, Higashiyamato-shi (JP); Ikuhiro Yamaguchi, Tokyo (JP); Manabu Takei, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/228,732

(22) Filed: Sep. 16, 2005

(30) Foreign Application Priority Data
Sep. 21, 2004 (JP) 2004-273206

(51) Int. Cl. G09G 3/30

(52) U.S. Cl. 345/77

(57) ABSTRACT

A drive circuit which drives an optical element in accordance with a gradation signal corresponding to display data includes an electric charge holding circuit which holds electric charges based on the gradation signal as a voltage component, and a driving current control circuit which generates a driving current based on the voltage component held in the electric charge holding circuit and supplies the generated driving current to the optical element. The driving current control circuit has at least one double-gate type thin film transistor. The transistor includes a semiconductor layer, a first gate electrode provided above the semiconductor layer, a second gate electrode provided below the semiconductor layer, and a source and drain electrodes provided on both end portion sides of the semiconductor layer.

### CROSS-REFERENCE TO RELATED APPLICATIONS

This application is based upon and claims the benefit of priority from prior Japanese Patent Application No. 2004-273206, filed Sep. 21, 2004, the entire contents of which are incorporated herein by reference.

### BACKGROUND OF THE INVENTION

1. Field of the Invention

The present invention relates to a drive circuit and a display apparatus comprising the drive circuit, and more particularly to a drive circuit which drives an optical element based on a driving current corresponding to a gradation signal, and a display apparatus comprising a display panel which has the drive circuit and a plurality of display pixels including optical elements.

2. Description of the Related Art

There has been conventionally known a self-luminous type display (a display apparatus) comprising a display panel in which display pixels are two dimensionally arranged, each of the display pixel including an optical element formed of a current control type light emitting element which operates to emit light with a predetermined luminance gradation in accordance with a current value of a driving current supplied thereto, like an organic electroluminescent element (which will be referred to as an “organic EL element” hereinafter), an inorganic electroluminescent element or a light emitting diode (LED). In particular, a self-luminous type display to which an active matrix drive mode is applied has a higher display response speed than that of a liquid crystal display (an LCD) widely utilized in various electronic devices, e.g., a portable information device, a personal computer, a television receiver or the like. Further, the self-luminous type display does not have view field angle dependency, and can achieve an increase in luminance/contrast and in fineness of a display image quality. Furthermore, the self-luminous type display does not require a backlight as different from the liquid crystal display, and hence the self-luminous type display has very advantageous characteristics that a further reduction in a thickness and a weight and/or a further decrease in power consumption is possible. Therefore, such a self-luminous type display has been actively studied and developed as a next-generation display.

In such a self-luminous type display, each display pixel constituting a display panel includes the optical element as well as a drive circuit (which will be referred to as a pixel drive circuit hereinafter for the convenience's sake) having a plurality of switching circuits which control light emission of the optical element. In the display of this type, various driving control mechanisms and/or control methods have been proposed.

FIG. 24 is a schematic block diagram showing a primary part of a conventional self-luminous type display.

FIGS. 25A and 25B are equivalent circuit diagrams each showing a structural example of a primary part of each display pixel which is applicable to the conventional self-luminous type display.

As shown in FIG. 24, a conventional self-luminous type display which is of an active matrix type (an organic EL display apparatus) generally comprises: a display panel 110P in which a plurality of display pixels EMp are arranged in a matrix form at respective intersections of a plurality of scanning lines (selection lines) SLp and a plurality of data lines (signal lines) DLp arranged to respectively extend in a row direction and a column direction; a scanning driver (a scanning line drive circuit) 120P which is connected with the scanning lines SLp; and a data driver (a data line drive circuit) 130P which is connected with the data lines DLp. In this apparatus, a gradation signal (a later-described gradation signal voltage Vpix or gradation signal current Ipix) corresponding to display data is generated in the data driver 130P, and supplied to each display pixel EMp through each data line DLp.

For example, as shown in FIG. 25A, the display pixel EMp having an organic EL element as an optical element is configured to have: a pixel drive circuit DP1 which comprises a first thin film transistor (TFT) Tr111 having a gate terminal connected with the scanning line SLp and source and drain terminals respectively connected with the data line DLp and a contact point N111, and a second thin film transistor Tr112 having a gate terminal connected with the contact point N111 and a source terminal S connected with a ground potential line and receiving a ground potential Vgnd; and an organic EL element (an optical element) OEL having an anode terminal connected with a drain terminal D of the second thin film transistor Tr112 of the pixel drive circuit DP1 and having a cathode terminal receiving a low-power source voltage Vss lower than the ground potential Vgnd.

Here, in FIG. 25A, reference symbol CP1 denotes a parasitic capacitance (a retention volume) formed or generated between the gate and the sources of the second thin film transistor Tr112. The first thin film transistor Tr111 is formed by an n-channel field effect transistor, and the second thin film transistor Tr112 is constructed by a p-channel field effect transistor.

In the display apparatus comprising the display panel 110P constituted by the display pixels EMp having such a configuration, first, sequentially applying a scanning signal Vsel which is on a selection level (a high level) to the scanning line SLp in each row from the scanning driver 120P turns on the first transistor Tr111 of the display pixel EMp (the pixel drive circuit DP1) in each row, thereby setting the display pixel EMp in a selection state.

In synchronization with this selection timing, a gradation signal voltage Vpix having a voltage value corresponding to display data is generated by the data driver 130P and applied to the data line DLp in each column, and the gradation signal voltage Vpix is thereby applied to the contact point N111 (that is, the gate terminal of the second transistor Tr112) through the first transistor Tr111 of each display pixel EMp (the pixel drive circuit DP1). As a result, the second transistor is turned on in a conductive state corresponding to the gradation signal voltage Vpix, a predetermined driving current flows to the low-power supply voltage Vss from the ground potential Vgnd through the second transistor Tr112 and the organic EL element OEL, and the organic EL element OEL operates to emit light with a luminance gradation corresponding to display data.

Subsequently, when a scanning signal Vsel which is on a non-selection level (a low level) is applied to the scanning line SLp from the scanning driver 120P, the first transistor Tr111 of the display pixel EMp in each row is turned off, the display pixel EMp is set to a non-selection state, and the data line DLp and the pixel drive circuit DP1 are electrically disconnected. At this time, the second transistor maintains the ON state based on a voltage which has been applied to the gate terminal of the second transistor Tr112 and held in the parasitic capacitance CP1, and a predetermined driving current based on the ground potential Vgnd flows to the organic EL element OEL through the second transistor Tr112, thereby maintaining the light emitting operation. This light emitting operation is controlled to continue for, e.g., one frame period until the gradation signal voltage Vpix corresponding to the next display data is applied to (written in) the display pixel EMP in each row.

Such a drive control method is referred to as a voltage specification mode (or a voltage application mode) since a current value of a driving current which flows to the organic EL element OEL to perform a light emitting operation with a predetermined luminance gradation by adjusting a voltage (the gradation signal voltage Vpix) applied to each display pixel EMp (the gate terminal of the second transistor Tr112 of the pixel drive circuit DP1).

On the other hand, a display pixel shown in FIG. 25B is configured to have in the vicinity of each intersection of a pair of scanning lines SLp1 and SLp2 and the data line DLp: a pixel drive circuit DP2 which comprises a first thin film transistor Tr121 having a gate terminal connected to the scanning line SLp1 and source and drain terminals respectively connected to the data line DLp and a contact point N121, a second thin film transistor Tr122 having a gate terminal connected with the scanning line SLp2 and source and drain terminals respectively connected with the contact point N121 and a contact point N122, a third thin film transistor Tr123 having a gate terminal connected with the contact point N122, a drain terminal connected to the contact point N121 and a source terminal connected with a high-voltage line and receiving a high voltage Vdd, and a fourth thin film transistor Tr124 having a gate terminal connected with the contact point N122 and a source terminal receiving the high-power supply voltage Vdd; and an organic EL element OEL having an anode terminal connected with a drain terminal of the fourth thin film transistor Tr124 of the pixel drive circuit DP2 and a cathode terminal receiving a ground potential Vgnd.

Here, in FIG. 25B, a symbol CP2 denotes a parasitic capacitance (a retention volume) formed or generated between the gate and the source of the third and fourth transistors Tr123 and Tr124. The first transistor Tr121 includes an n-channel field effect transistor, and each of the second to the fourth transistors Tr122 to Tr124 is formed of a p-channel field effect transistor.

In the display apparatus comprising the display panel 110P constituted of the display pixels EMp having such a configuration, first, a scanning signal Vsel1 which is on the high level is applied to the scanning line SLp1 in each row and a scanning signal Vsel2 which is on the low level is applied to the scanning line SLp2 from the scanning driver 120P to set the display pixel EMp (the pixel drive circuit DP2) in each row in the selection state, and the first to third thin film transistors Tr121, Tr122 and Tr123 are turned on. In synchronization with this selection timing, a gradation signal current Ipix having a current value corresponding to display data is generated by the data driver 130P and supplied to the data line DLp in each column, and the gradation signal current Ipix thereby flows the high-voltage Vdd line through the first and third transistors Tr121 and Tr123.

At this time, since the gate and the drain of the third transistor Tr123 are electrically short-circuited by the second transistor Tr122, the third transistor is turned on in a saturation region. As a result, a current level of the gradation signal current Ipix is converted into a voltage level by the third transistor Tr123 so that a predetermined voltage is generated between the gate and the source thereof (a write operation).

The fourth transistor Tr124 is turned on in accordance with the voltage generated between the gate and the source of the third transistor Tr123, a predetermined driving current based on the high-power supply voltage Vdd flows to the ground potential Vgnd through the fourth transistor Tr124 and the organic EL element OEL, and hence the organic EL element operates to emit light with a luminance gradation corresponding to display data (a light emitting operation).

Subsequently, when the scanning signal Vsel2 which is on the high level is applied to the scanning line SLp2, the second transistor Tr122 is turned off. As a result, the voltage generated between the gate and the source of the third transistor Tr123 is held by the parasitic capacitance CP2. Then, when the scanning signal Vsel1 which is on the low level is applied to the scanning line SLp1, the first transistor Tr121 is turned off. As a result, the data line DLp and the pixel drive circuit DP2 are electrically disconnected. Consequently, the fourth transistor Tr124 continues the ON state by a potential difference based on the voltage held in the parasitic capacitance CP2, a predetermined driving current flows to the ground potential from the high-power supply voltage Vdd through the fourth transistor Tr124 and the organic EL element OEL, thereby continuing the light emitting operation of the organic EL element OEL. This light emitting operation is controlled to continue for, e.g., one frame period until the gradation signal current Ipix corresponding to the next display data is written in each display pixel EMp.

Such a driving control method is referred to as a current specification mode or a current application mode since a current value of a driving current which flows to the organic EL element OEL is controlled to perform the light emitting operation with a predetermined luminance gradation by adjusting a voltage held in the parasitic capacitance (the retention volume) CP2 in accordance with a current (the gradation signal current Ipix) supplied to each display pixel EMp (between the source and the drain of the thin film transistor Tr123 of the pixel drive circuit DP2).

The circuit configurations shown in FIGS. 25A and 25B are just the examples of the display pixel (the pixel drive circuit) corresponding to the drive control method adopting the voltage specification mode and the current specification mode. The number or channel polarities of switching circuits (the thin film transistors) constituting the pixel drive circuit have been devised in many ways and, for example, there is known a circuit configuration using thin film transistors having a single channel polarity alone.

In the display panel to which the display pixels (the pixel drive circuit) having the above-described circuit configuration are applied, when the number of pixels is increased with an increase in a size of the display panel or realization of high definition, manufacturing processes are increased or complicated, a product yield ratio is reduced, or a product cost rises. Thus, by adopting, e.g., a transistor configuration using amorphous silicon to each thin film transistor constituting the pixel drive circuit, the manufacturing processes can be simplified and its manufacturing technology can be established as compared with an example adopting single-crystal silicon. Additionally, it is possible to apply an amorphous silicon manufacturing process with high element characteristic stability, thereby inexpensively realizing a display panel which is superior in element characteristics.

However, since the amorphous silicon thin film transistor has low electron mobility, when such an amorphous silicon thin film transistor is applied to, e.g., a light emission drive type thin film transistor which supplies a driving current to an optical element, it is necessary to (1) set a large gate electrode width (a gate width) of the thin film transistor and (2) set a short length (a gate length) of a gate electrode, or (3) set a high voltage (a gate voltage) applied to the gate in order to allow a predetermined driving current to flow.

In this case, when a large gate width is set, an area of the gate is increased in a predetermined area where each display pixel is formed. Therefore, an area of a light emission region of the optical element is relatively decreased, which results in a reduction in a numerical aperture.

Further, setting a short gate length requires microfabrication, and hence there is a problem of a reduction in a product yield ratio or an increase in a product cost.

Furthermore, when a high gate voltage is set, power consumption is increased, deterioration in characteristics of the thin film transistor advances to shorten a life duration, and an operation failure or the like is generated, thereby lowering reliability of the product.

### BRIEF SUMMARY OF THE INVENTION

The present invention has advantages of achieving an improvement in a numeral aperture or reliability and enhancing a display quality in a display apparatus which comprises a display panel having an optical element and a drive circuit which drives the optical element in each display pixel, and displays image information corresponding to display data.

To obtain the above-described advantages, the drive circuit according to a first aspect of the present invention comprises: at least an electric charge holding circuit which holds electric charges based on the gradation signal as a voltage component; and a drive current control circuit which generates a driving current based on the voltage component held in the electric charges holding circuit to be supplied to the optical element, wherein the drive current control circuit has at least one double-gate type thin film transistor configuration including: a semiconductor layer; a first gate electrode provided above the semiconductor layer; a second gate electrode provided below the semiconductor layer; and a source electrode and a drain electrode provided on both end portion sides of the semiconductor layer.

The gradation signal may be a signal current having a current value corresponding to the display data, or a signal voltage having a voltage value corresponding to the display data.

Preferably, the first gate electrode and the second gate electrode in the double-gate type thin film transistor are electrically connected with each other, and the semiconductor layer is formed of amorphous silicon.

The electric charge holding circuit preferably has a capacitance component which holds the electric charges, and includes a capacitance component which is formed when one of the source electrode and the drain electrode faces the first gate electrode and the second gate electrode.

The optical element may be a current control type light emitting element which operates to emit light with a predetermined luminance gradation in accordance with a current value of the driving current, and it is, e.g., an organic electroluminescent element.

In the double-gate type thin film transistor, preferably, the source electrode and the drain electrode extend on the semiconductor layer, and the source electrode and the drain electrode have the same overlap dimension on the semiconductor layer. Alternatively, an overlap dimension of one of the source electrode and the drain electrode connected with the optical element on the semiconductor layer may be shower than an overlap dimension of the other electrode on the semiconductor layer.

An insulating film is provided between the source and drain electrodes which extend on the semiconductor layer, and the first gate electrode may be provided in a region between the source electrode and the drain electrode on the semiconductor layer.

Furthermore, the drive circuit preferably further includes a gradation signal control circuit which controls a timing at which the gradation signal is supplied to the electric charge holding circuit, and the gradation signal control circuit has at least one thin film transistor configuration including a single gate electrode or one double-gate type thin film transistor configuration.

To obtained the above-described advantages, the display apparatus according to a second aspect of the present invention comprises at least a display panel which has: a plurality of scanning lines and a plurality of signal lines arranged to be orthogonal to each other; and a plurality of display pixels arranged in the vicinity of respective intersections of the respective scanning lines and signal lines, each display pixel having an optical element and a drive circuit which controls at least an operation of the optical element, the drive circuit including: at least an electric charge holding circuit which holds electric charges based on the gradation signal as a voltage component; and a driving current control circuit which generates a driving current based on the voltage component held in the electric charge holding circuit to be supplied to the optical element, thereby controlling an operation of the optical element, the driving current control circuit having at least one double-gate type thin film transistor configuration comprising: a semiconductor layer; a first gate electrode provided above the semiconductor layer; a second gate electrode provided below the semiconductor layer; and a source electrode and a drain electrode which are provided on both end portion sides of the semiconductor layer.

Preferably, the display apparatus further comprises: a scanning drive circuit which sequentially applies a selection signal to each of the plurality of scanning lines in the display panel to set a selection state in which the gradation signal is written in the display pixel corresponding to each scanning line; and a signal drive circuit which generates the gradation signal corresponding to the display pixel set to the selection state in accordance with the display data and supplies the generated gradation signal to the plurality of signal lines.

The gradation signal may be a signal current having a current value corresponding to the display data, or a signal voltage having a voltage value corresponding to the display data.

Preferably, the first gate electrode and the second gate electrode in the double-gate type thin film transistor are electrically connected with each other, and the semiconductor layer is formed of amorphous silicon.

The electric charge holding circuit preferably has a capacitance component in which the electric charges are held, and includes a capacitance component formed when one of the source electrode and the drain electrode faces the first gate electrode and the second gate electrode.

The optical element preferably has a current control type light emitting element which operates to emit light with a predetermined luminance gradation in accordance with a current value of the driving current, and it is, e.g., an organic electroluminescent element.

In the double-gate type thin film transistor, the source and drain electrodes preferably extend on the semiconductor layer, and the source electrode and the drain electrode have the same overlap dimensions on the semiconductor layer. Alternatively, the overlap dimensions of one of the source electrode and the drain electrode connected with the optical element on the semiconductor layer may be shorter than overlap dimensions of the other electrode on the semiconductor layer.

An insulating film is preferably provided between the source electrode and the drain electrode which extend on the semiconductor layer, and the first gate electrode may be provided in a region between the source electrode and the drain electrode on the semiconductor layer.

Furthermore, the drive circuit further includes a gradation signal control circuit which controls a timing at which the gradation signal is supplied to the electric charge holding circuit, and the gradation signal control circuit has at least one thin film transistor configuration including a single gate electrode or one double-gate type thin film transistor configuration.

### BRIEF DESCRIPTION OF THE SEVERAL VIEWS OF THE DRAWING

FIG. 1 is a block diagram showing an example of an entire configuration of a display apparatus according to a first embodiment of the present invention;

FIG. 2 is a circuit configuration view showing a first embodiment of a display pixel including a pixel drive circuit according to the present invention;

FIG. 3 is a circuit configuration view showing a second embodiment of a display pixel including a pixel drive circuit according to the present invention;

FIGS. 4A and 4B are conceptual views showing operation states of the display pixel (a pixel drive circuit) according to the second embodiment;

FIG. 5 is a timing chart showing a basic operation of the display pixel to which the pixel drive circuit according to the second embodiment is applied;

FIGS. 6A and 6B are a cross-sectional structural view and a circuit diagram showing a first structural example of an element configuration of a double-gate type transistor which is applied to a light emission drive type transistor of the pixel drive circuit according to the present invention;

FIGS. 7A, 7B and 7C are schematic structural views showing an example of the element configuration when the double-gate type transistor according to the first structural example is applied to the display pixel (the pixel drive circuits) according to each embodiment, in which FIGS. 7B and 7C are cross-sectional views respectively taken along a line A-A and a line B-B in FIG. 7A;

FIGS. 8A and 8B are views showing voltage-current characteristics (simulation results) in a state where a top gate terminal and a bottom gate terminal are electrically independent in the double-gate type transistor according to the first structural example;

FIGS. 9A and 9B are views showing voltage-current characteristics (simulation results) in a state where the top gate terminal and the bottom gate terminal are electrically connected (short-circuited) in the double-gate type transistor according to the first structural example;

FIGS. 10A and 10B are circuit diagrams showing simulation models (simplified equivalent circuits) which are used to verify a write operation of the double-gate type transistor in the pixel drive circuit in the second embodiment;

FIG. 11 is a characteristic diagram (a simulation result) showing a relationship (current characteristics) between a gradation signal current (an input current) and a light emission driving current (an output current) when the double-gate type transistor according to the first structural example is applied to the pixel drive circuit in the second embodiment;

FIG. 12 is a characteristic diagram (a simulation result) showing a relationship between the gradation signal current (the input current) and a write ratio with respect to the pixel drive circuit when the double-gate type transistor according to the first structural example is applied to the pixel drive circuit in the second embodiment;

FIG. 13 is a cross-sectional structural view showing another structural example of the element configuration of the double-gate type transistor according to the first structural example;

FIGS. 14A and 14B are a cross-sectional structural view and a circuit diagram showing a second structural example of the element configuration of the double-gate type transistor applied to the light emission drive transistor of the pixel drive circuit according to the present invention;

FIG. 15 is a view (a simulation result) showing voltage-current characteristics in a state where a top gate terminal and a bottom gate terminal are electrically independent in the double-gate type transistor according to the second structural example;

FIGS. 16A and 16B are views illustrating voltage-current characteristics when the double-gate type transistor according to the second structural example is applied to the pixel drive circuit in the second embodiment;

FIG. 17 is a characteristic diagram (a simulation result) showing a relationship (current characteristics) between a gradation signal current (an input current) and a light emission driving current (an output current) when the double-gate type transistor according to the second structural example is applied to the pixel drive circuit in the second embodiment;

FIG. 18 is a characteristic diagram (a simulation result) showing a relationship between the gradation signal current (the input current) and a write ratio with respect to the pixel drive circuit when the double-gate type transistor according to the second structural example is applied to the pixel drive circuit in the second embodiment;

FIGS. 19A and 19B are views showing another structural example of the element configuration of the double-gate type transistor according to the second structural example and another circuit configuration example when the double-gate type transistor is applied to a pixel drive circuit (a display pixel) corresponding to a current application mode;

FIGS. 20A and 20B are a cross-sectional structural view and a circuit diagram showing a third structural example of the element configuration of the double-gate type transistor applied to the light emission drive transistor of the pixel drive circuit according to the present invention;

FIGS. 21A, 21B and 21C are schematic structural views showing an example of the element configuration when the double-gate type transistor according to the third structural example is applied to the display pixel (the pixel drive circuit) according to each embodiment, in which FIGS. 21B and 21C are cross-sectional views respectively taken along a line C-C and a line D-D in FIG. 21A;

FIGS. 22A and 22B are views showing voltage-current characteristics (simulation results) in a state where a top gate terminal and a bottom gate terminal are electrically independent in the double-gate type transistor according to the third structural example;

FIGS. 23A and 23B are views showing voltage-current characteristics (simulation results) in a state where the top gate terminal and the bottom gate terminal are electrically connected (short-circuited) in the double-gate type transistor according to the third structural example;

FIG. 24 is a schematic structural view showing a primary part of a conventional self-luminous type display; and

FIGS. 25A and 25B are equivalent circuit diagrams showing primary part structural examples of each display pixel which is applicable to the conventional light emission type display.

### DETAILED DESCRIPTION OF THE INVENTION

Embodiments of a pixel drive circuit and a display apparatus including the pixel drive circuit in a display panel according to the present invention will now be described in detail hereinafter.

<Overall Configuration of Display Apparatus>

An overall configuration of a display apparatus according to the present invention will be first described with reference to the accompanying drawings.

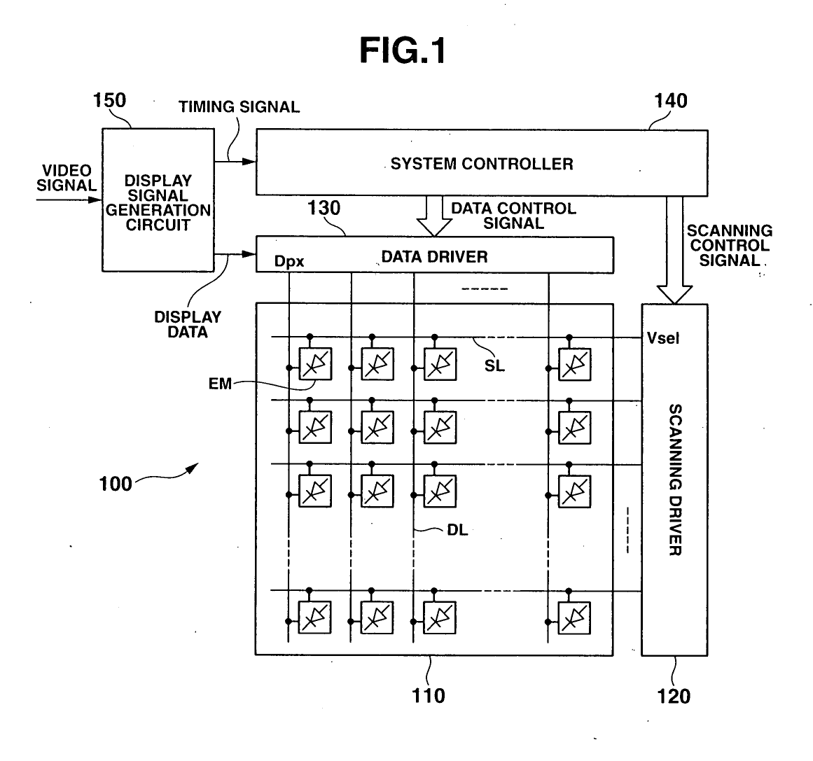

FIG. 1 is a block diagram showing an example of an overall configuration of a display apparatus according to the present invention.

As shown in FIG. 1, a display apparatus 100 according to the present invention generally comprises a display panel 110 in which a plurality of display pixels EM each including an optical element having a current control type light emitting element are arranged in the vicinity of respective intersections of a plurality of scanning lines SL and a plurality of data lines (signal lines) DL. The lines SL and DL are respectively arranged to extend in a row direction and a column direction. A scanning driver (a scanning drive circuit) 120 is connected with the scanning lines SL in the display panel 110, and sequentially applies a scanning signal Vsel to each scanning line SL at a predetermined timing to set (scan) the display pixel EM in each row in a selection state. A data driver (a signal drive circuit) 130 is connected with the data lines DL in the display panel 110, and generates and supplies a gradation signal Dpx based on display data to each data line DL. A system controller 140 generates and outputs at least a scanning control signal and a data control signal required to control operating states of the scanning driver 120 and the data driver 130. A display signal generation circuit 150 generates display data (a display signal) comprising a digital signal based on a video signal supplied from the outside of the display apparatus 100, supplies the generated data to the data driver 130A, extracts or generates a timing signal (a system clock or the like) required to display an image of the display data in the display panel 110 and supplies the extracted or generated signal to the system controller 140.

(Display Panel)

Each of the display pixels EM arranged in a matrix form in the display panel 110 has a pixel drive circuit which controls, based on the scanning signal Vsel applied to the scanning line SL from the scanning driver 120 and a gradation signal Dpx (which is specifically a gradation signal voltage Vpix or a gradation signal current Ipix) supplied to the data line DL from the signal driver 130, a write operation of the gradation signal Dpx with respect to the display pixel and a light emitting operation of the optical element with a luminance gradation based on the gradation signal Dpx. Each display pixel element further includes an optical element having a current control type light emitting element such as an organic EL element OEL or a light emitting diode which operates to emit light with a luminance gradation corresponding to a current value of a driving current supplied from the pixel drive circuit.

In this example, the pixel drive circuit is set to a selection state or a non-selection state based on the scanning signal Vsel, and has a function of fetching the gradation signal Dpx corresponding to display data and holding this signal as a voltage level in the selection state, and allowing a driving current corresponding to the held voltage level to flow to the optical element to continuously emit light with a predetermined luminance gradation in the non-selection state. A concrete structural example of the display pixel applicable to the present invention will be described later.

(Scanning Driver)

The scanning driver 120 sequentially applies the scanning signal Vsel which is on a selection level (e.g., a high level) to each scanning line SL based on a scanning control signal supplied from the system controller 140 to set the display pixel EM in each row in the selection state, and controls the gradation signal Dpx based on the display data fed from the data driver 130 through each data line DL to be written in the pixel drive circuit of each display pixel EM.

Here, the scanning driver 120 can adopt a known configuration in which a plurality of shift blocks each including a shift register and a buffer are provided in accordance with the respective scanning lines SL, and a shift signal is sequentially shifted by the shift register based on a scanning control signal (a scanning start signal, a scanning clock signal or the like) supplied from the later-described system controller 140 while the generated shift signal is converted into a predetermined voltage level (a high level) through the buffer so that the converted signal is sequentially output to each scanning line SL as the scanning signal Vsel.

(Data Driver)

The data driver 130 fetches and holds display data fed from the display signal generation circuit 150 at a predetermined timing, based on a data control signal (an output enable signal, a data latch signal, a sampling start signal, a shift clock signal or the like) supplied from the system controller 140, generates an analog signal voltage or an analog signal current corresponding to the display data, and supplies the generated voltage or current to each data line DL as the gradation signal Dpx (a gradation signal voltage Vdata or a gradation signal current Ipix).

(System Controller)

The system controller 140 generates and outputs a scanning control signal and a data control signal with respect to at least the scanning driver 120 and the data driver 130, based on a timing signal supplied from the later-described display signal generation circuit 150 to operate each driver at a predetermined timing so that the scanning signal Vsel and the gradation signal Dpx are generated, and applies the generated signals to each scanning line SL and each data line DL to continuously execute a light emitting operation in each display pixel EM so that image information based on a predetermined video signal is displayed in the display panel 110.

(Display Signal Generation Circuit)

The display signal generation circuit 150 extracts a luminance gradation signal component from, e.g., a video signal supplied from the outside of the display apparatus 100, and supplies the luminance gradation signal component to the data driver 130 as display data including a digital signal in accordance with each row in the display panel 110. Here, when the video signal includes a timing signal component which defines a display timing of image information like a television broadcast signal (a composite video signal), the display signal generation circuit 150 may have a function of extracting the luminance gradation signal component as well as a function of extracting the timing signal component and supplying it to the system controller 140 as shown in FIG. 1. In this case, the system controller 140 generates a scanning control signal and a data control signal which are individually supplied to the scanning driver 120 or the data driver based on the timing signal fed from the display signal generation circuit 150.

When the video signal supplied from the outside of the display apparatus 100 is formed of a digital signal and the timing signal is supplied separately from the video signal, the video signal (the digital signal) is fed to the data driver 130 as display data, and the timing signal is directly supplied to the system controller 140. Thus, the display signal generation circuit 150 can be eliminated.

<Display Pixel>

A concrete configuration of each display pixel arranged in the display panel applied to the display apparatus according to the foregoing embodiment will now be described in detail with reference to the accompanying drawings.

Here, the display pixel applied to the display apparatus according to the present invention may comprise a pixel drive circuit corresponding to a drive control method adopting a voltage application mode, or may comprise a pixel drive circuit corresponding to a current application mode. Further, in the following structural example, although a description will be given as to each example of the display pixel having the pixel drive circuit corresponding to each drive control method, the present invention is not restricted to such an example, and the display pixel may have any other circuit configuration as long as it is configured to hold a voltage component corresponding to a gradation signal voltage or a gradation signal current based on display data, generate a driving current based on the voltage component and supply the generated driving current to the optical element.

### FIRST EMBODIMENT

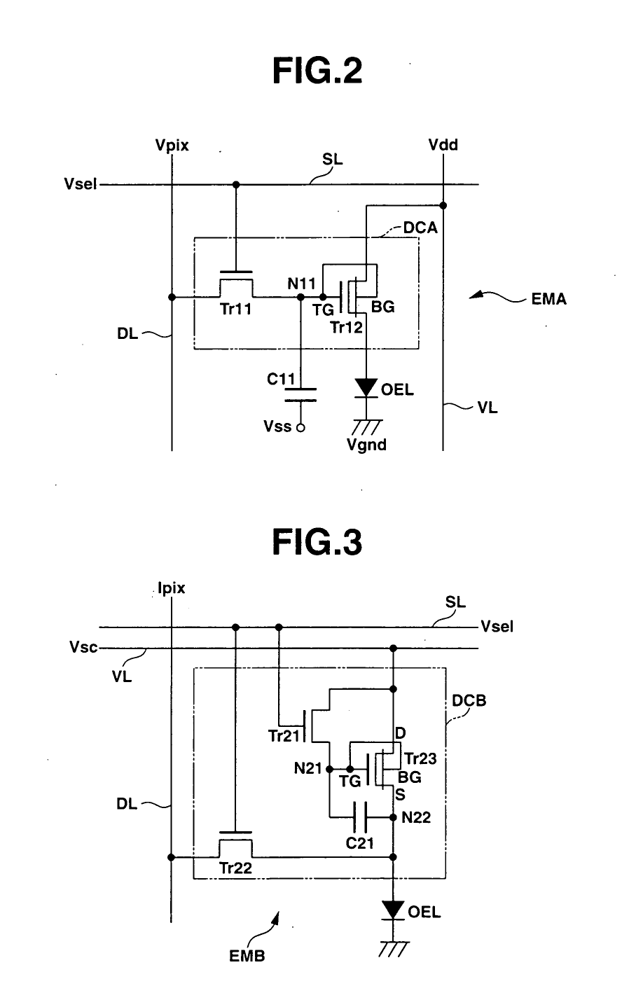

FIG. 2 is a circuit configuration view showing a first embodiment of the display pixel having the pixel drive circuit according to the present invention.

As shown in FIG. 2, the display pixel EMA according to this embodiment has, in the vicinity of each intersection of the scanning lines SL and the data lines DL arranged to be orthogonal to each other on the display panel 110, a pixel drive circuit DCA and an organic EL element (an optical element) OEL. The pixel drive circuit DCA includes a thin film transistor or a first transistor (a gradation signal control circuit) Tr11 having a gate terminal connected with the scanning line SL and source and drain terminals respectively connected with the data line DL and a contact point N11, a double-gate type thin film transistor or a second transistor (a driving current control circuit) Tr12 having a top gate terminal TG and a bottom gate terminal BG each connected with the contact point N11 and a source terminal S connected with a power supply line VL (a high-potential power supply Vdd). A capacitor (an electric charge holding circuit) C11 is connected between the contact point N11 and a line of a predetermined low-potential power supply Vss (e.g., a ground potential). The organic EL element OEL has an anode terminal connected with a drain terminal D of the double-gate type transistor Tr12 of the pixel drive circuit DCA and having a cathode terminal connected with a ground potential, for example.

In the pixel drive circuit DCA according to this embodiment, each of the first and second transistors Tr11 and Tr12 has an element configuration formed of an n-channel semiconductor layer as a channel region and, in particular, at least the semiconductor layer of the double-gate type transistor Tr12 is formed of amorphous silicon.

It should be noted that the pixel drive circuit according to this embodiment has a configuration in which, at least as a light emission drive switching element which supplies a driving current to the organic EL element OEL which is the optical element, a later-described double-gate type thin film transistor (the double-gate type transistor) is applied in place of a general single-gate type field effect transistor (a thin film transistor). An element configuration and element characteristics of this double-gate type transistor will be described later in detail.

In a drive control operation of the pixel drive circuit DCA having such a configuration, first, a high-level scanning signal Vsel is supplied from the scanning driver 120 to the scanning line SL to turn on the first transistor Tr11, and the pixel drive circuit DCA is thereby set to a selection state. In synchronization with this selection state, a gradation signal voltage Vpix having a voltage value based on display data is applied from the data driver 130 through the data line DL. Thus, the gradation signal voltage Vpix is applied to the top gate terminal TG and the bottom gate terminal BG of the double-gate type transistor Tr12 through the thin film transistor Tr11. As a result, the second transistor Tr12 is turned on in a conductive state corresponding to the gradation signal voltage Vpix, a predetermined driving current flows from the power supply line VL through the second transistor Tr12, and the organic EL element OEL emits light with a luminance gradation corresponding to the display data.

Subsequently, when a low-level scanning signal Vsel is applied to the selection line SL, the first transistor Tr11 is turned off so that the pixel drive circuit DCA is set to a non-selection state. As a result, the data line DL and the pixel drive circuit DCA are electrically disconnected, the voltage applied to the top gate terminal TG and the bottom gate terminal BG of the second transistor Tr12 is held in the capacitor C11 so that the double-gate type transistor Tr12 maintains the ON state, and a predetermined driving current flows to the organic EL element OEL from the power supply line VL through the second transistor Tr12, thereby continuing the light emitting operation. This light emitting operation is controlled to continue for, e.g., one frame period until the gradation signal voltage Vpix corresponding to the next display data is written in the display pixel EMA (the pixel drive circuit DCA).

### SECOND EMBODIMENT

FIG. 3 is a circuit configuration view showing a second embodiment of the display pixel including the pixel drive circuit according to the present invention.

As shown in FIG. 3, a display pixel EMB according to this embodiment has a pixel drive circuit DCB and an organic EL element (an optical element) OEL in the vicinity each intersection of the scanning lines SL and the data lines DL extend to be orthogonal to each other on the display panel 110. The pixel drive circuit DCB includes a first thin film transistor Tr21 having a gate terminal connected with the scanning line SL and source and drain terminals respectively connected with a power supply line VL (a power supply voltage Vsc) and a contact point N21, a second thin film transistor (a gradation signal control circuit) Tr22 having a gate terminal connected with the scanning line SL and source and drain terminals respectively connected with the data line DL and the contact point N22, a double-gate type thin film transistor or a third transistor (a driving current control circuit) Tr23 having a top gate terminal TG and a bottom gate terminal BG each connected with the contact point N21 and a source terminal S and a drain terminal D respectively connected with the contact point N22 and the power supply line VL; and a capacitor (an electric charge holding circuit) C21 connected between the contact point N21 and the contact point N22. The organic EL element OEL has an anode terminal connected with the contact point N22 of the pixel drive circuit DCB and a cathode terminal connected with a ground potential. Here, the capacitor C21 may be a capacitance component formed between a top gate electrode, a bottom gate electrode and a source electrode of the double-gate type transistor Tr23.

In the pixel drive circuit DCB according to this embodiment, each of the first to third transistors Tr21, Tr22, Tr23 has an element configuration comprising an n-channel semiconductor layer as a channel region and, in particular, at least the semiconductor layer of the double-gate type transistor Tr23 is formed of amorphous silicon.

It should be noted that the pixel drive circuit according to this embodiment has a configuration in which, at least as a light emission drive switching element, a later-described double-gate type thin film transistor (a double-gate type transistor) is applied in place of a general single-gate type field effect transistor (a thin film transistor).

A drive control method of the pixel drive circuit in the display pixel according to this embodiment will now be described in detail. Here, a description will be given while associating with an image information display operation in the display panel 110 in which the plurality of display pixels each comprising the pixel drive circuit having the above-described circuit configuration are two-dimensionally arranged.

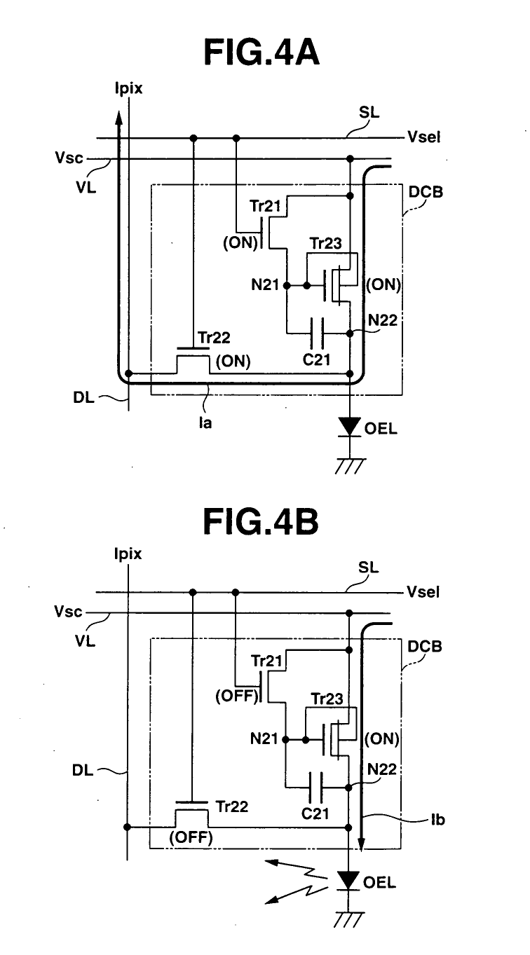

FIGS. 4A and 4B are conceptual views showing operating states of the display pixel according to this embodiment.

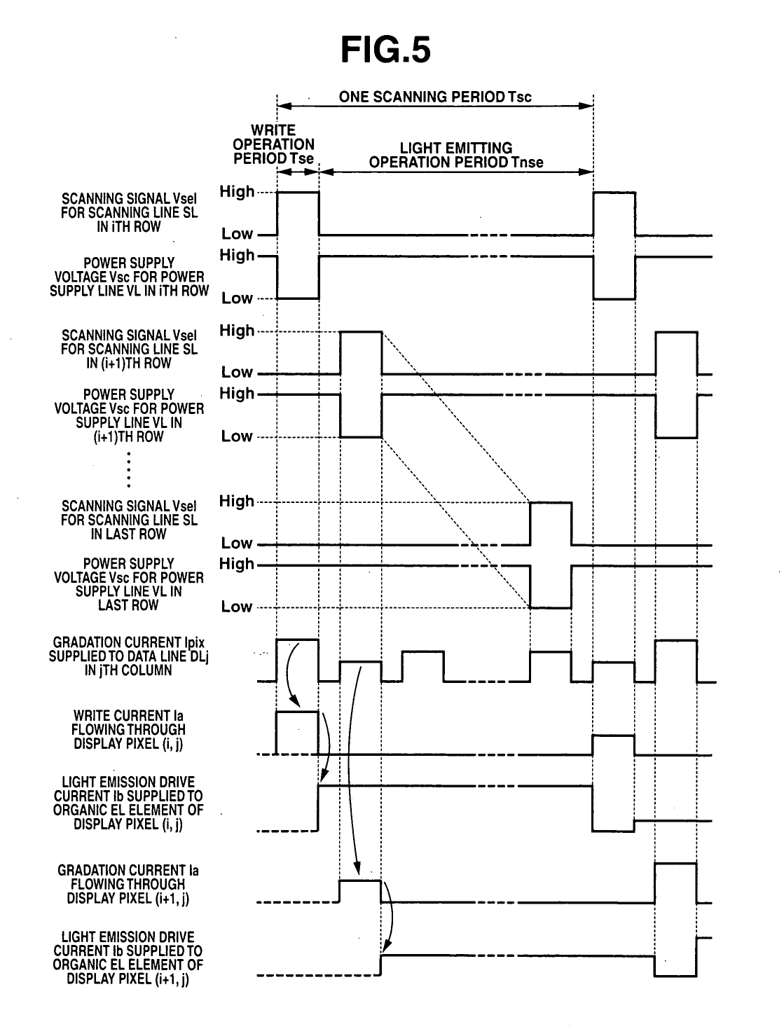

FIG. 5 is a timing chart showing a basic operation of the display pixel to which the pixel drive circuit according to this embodiment is applied.

For example, as shown in FIG. 5, the drive control method (a light emission drive control) of the optical element (the organic EL element OEL) in the pixel drive circuit DCB having the above-described configuration is executed by effecting a setting to include a write operation period (a selection period) Tse and a light emitting operation period (a non-selection period) Tnse. In the write operation period Tse, one scanning period Tsc is determined as one cycle, the display pixel EMB connected with the scanning line SL is selected, and the gradation signal current Ipix corresponding to display data is written in the selected display pixel EMB and held as a voltage component within this one scanning period Tsc. In the light emitting operation period Tnse, a driving current corresponding to the display data is generated and supplied to the organic EL element OEL, based on the voltage component written and held in the write operation period Tse. Thus, a light emitting operation is performed with a predetermined luminance gradation (Tsc≧Tse+Tnse). Here, the write operation period Tse which is set in accordance with the scanning line SL in each row is set in such a manner that a temporal overlap is not generated.

(Write Operation Period)

First, in the write operation period Tse of the display pixel EMB, as shown in FIG. 5, the high-level scanning signal Vsel is applied to the scanning line (e.g., a scanning line in an ith row; i is an arbitrary natural number which specifies the scanning line SL) SL from the scanning driver 120, and the display pixel EMB in this row is set to the selection state. Additionally, the low-level power supply voltage Vsc is applied to the power supply line VL of the display pixel EMB in this row. Further, in synchronization with this timing, a gradation signal current with a negative polarity (−Ipix) which has a current value corresponding to the display data in this row is supplied to the data line DL from the data driver 130.

As a result, the thin film transistors Tr21 and Tr22 constituting the pixel drive circuit DCB are turned on, the low-level power supply voltage Vsc is applied to the contact point N21 (that is, the top gate terminal TG and the bottom gate terminal BG of the double-gate type transistor Tr23 and one end side of the capacitor C21), and an operation of drawing the gradation signal current with the negative polarity (−Ipix) is performed by the data driver 130 through the data line DL. As a result, a voltage level whose potential is lower than the low-level power supply voltage Vsc is applied to the contact point N22 (that is, the source terminal S of the double-gate type transistor Tr23 and the other end side of the capacitor C21).

When a potential difference is generated between the contact points N21 and N22 (between the gate and the source of the double-gate type transistor Tr23) in this manner, the double-gate type transistor Tr23 is turned on, and a write current Ia corresponding to a current value of the gradation signal current Ipix flows to the data driver 130 from the power supply line VL through the double-gate type transistor Tr23, the contact point N22, the thin film transistor Tr22 and the data line DL as shown in FIG. 4A.

At this time, electric charges corresponding to the potential difference generated between the contact points N21 and N22 (between the gate and the source of the double-gate type transistor Tr23) are stored in the capacitor C21, and it is held (charged) as a voltage component. Furthermore, the power supply voltage Vsc having a voltage level equal to or lower than the ground potential Vgnd is applied to the power supply line VL, and the write current Ia is controlled to flow toward the data line DL. Therefore, a potential applied to the anode terminal (the contact point N22) of the organic EL element OEL becomes lower than a potential (the ground potential Vgnd) of the cathode terminal of the same, and a reverse bias voltage is applied to the organic EL element OEL. Accordingly, the driving current does not flow through the organic EL element OEL, thereby effecting no light emitting operation.

(Light Emitting Operation Period)

Then, in the light emitting operation period Tnse after end of the write operation period Tse, as shown in FIG. 5, the low-level scanning signal Vsel is applied to the scanning line SL from the scanning driver 120, so that the display pixel EMB is set to the non-selection state. Moreover, the high-level power supply voltage Vsc is applied to the power supply line VL of the display pixel EMB in this row. Additionally, in synchronization with this timing, the operation of drawing the gradation signal current Ipix (a gradation signal current Ipix supply operation) by the data driver 130 is stopped.

As a result, the thin film transistors Tr21 and Tr22 constituting the pixel drive circuit DCB are turned off, application of the power supply voltage Vsc to the contact point N21 (that is, the top gate terminal TG and the bottom gate terminal BG of the double-gate type transistor Tr23 and one end side of the capacitor C21) is interrupted, and application of the voltage level due to the gradation signal current Ipix drawing operation to the contact point N22 (that is, the source terminal S of the double-gate type transistor Tr23 and the other end side of the capacitor C21) by the data driver 130 is also interrupted. Therefore, the capacitor C21 holds the electric charges stored in the above-described write operation period Tse.

The potential difference between the contact points N21 and N22 (between the gate and the source of the double-gate type transistor Tr23) is held by holding the charging voltage in the write operation by the capacitor C21 in this manner, and hence the double-gate type transistor Tr23 maintains the ON state. Further, since the power supply voltage Vsc having a voltage level higher than that of the ground potential Vgnd is applied to the power supply line VL, the potential applied to the anode terminal (the contact point N22) of the organic EL element OEL becomes higher than the potential (the ground potential) of the cathode terminal of the same.

Therefore, as shown in FIG. 4B, a predetermined driving current Ib flows from the power supply line VL to the organic EL element OEL in a forward bias direction through the double-gate type transistor Tr23 and the contact point N22. Thus, the organic EL element OEL emits light. Here, a potential difference (a charging voltage) based on the electric charges stored in the capacitor C21 corresponds to a potential difference when the write current Ia corresponding to the gradation signal current Ipix flows in the double-gate transistor Tr23. Consequently, the driving current Ib supplied to the organic EL element OEL has a current value equivalent to that of the write current Ia. As a result, in the light emitting operation period Tnse after the write operation period Tse, the driving current Ib is continuously supplied through the double-gate type transistor Tr23, based on the voltage component corresponding to the display data (the gradation signal current Ipix) written in the write operation period Tse, so that the organic EL element OEL continues the operation of emitting light with a luminance gradation corresponding to the display data.

When the above-described series of operation is sequentially repeatedly executed with respect to all the scanning lines SL constituting the display panel 110, display data corresponding to one screen of the display panel is written, and light emission is carried out with a predetermined luminance gradation, thereby displaying desired image information.

Here, in the pixel drive circuit DCB according to this embodiment, at least the semiconductor layer (a channel layer) constituting the double-gate type transistor Tr23 is formed of n-channel amorphous silicon, and the thin film transistors Tr21 and Tr22 also have the same channel polarity (the n-channel). Therefore, by forming the semiconductor layer (the channel layer) of the n-channel amorphous silicon, the already established amorphous silicon manufacturing technology can be applied to relatively inexpensively manufacture the pixel drive circuit having stable operation characteristics.

In the pixel drive circuit DCB according to this embodiment, as described above (see FIG. 5), although the power supply voltage Vsc having a predetermined voltage value must be applied to the power supply line VL, a configuration realizing this may be as follows. For example, in addition to the configuration of the display apparatus 100 shown in FIG. 1, a power supply driver connected with the plurality of power supply lines VL arranged in parallel with the respective scanning lines SL of the display panel 110 is provided, and the power supply voltage Vsc having a predetermined voltage value is applied from the power supply driver to the power supply line VL in a row to which the scanning signal Vsel is applied (the display pixel EMB set to the selection state) by the scanning driver 120 based on a power supply control signal fed from the system controller 140 at a timing (see FIG. 5) synchronized with the scanning signal Vsel output from the scanning driver 120. Alternatively, since application is performed with respect to the power supply line VL at the timing synchronized with the scanning signal Vsel output from the scanning driver, the scanning signal Vsel (or a shift output signal required to generate the scanning signal) may be subjected to reversal processing, and the reversed signal may be amplified to a predetermined signal level and applied to the power supply line VL.

<Element Configuration and Element Characteristics of Double-Gate Type Transistor>

A description will now be given as to an element configuration and element characteristics of the double-gate type transistor applied as the light emission drive transistor of the pixel drive circuit described in conjunction with each embodiment with reference to the accompanying drawings.

### FIRST STRUCTURAL EXAMPLE

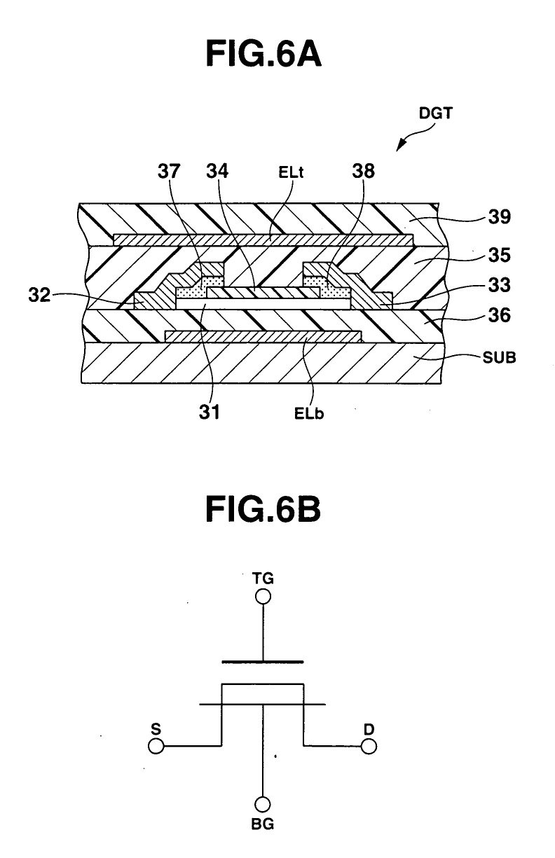

FIGS. 6A and 6B are cross-sectional structural view and a circuit diagram showing a first structural example of an element configuration of the double-gate type transistor applied to the light emission drive transistor of the pixel drive circuit according to the present invention.

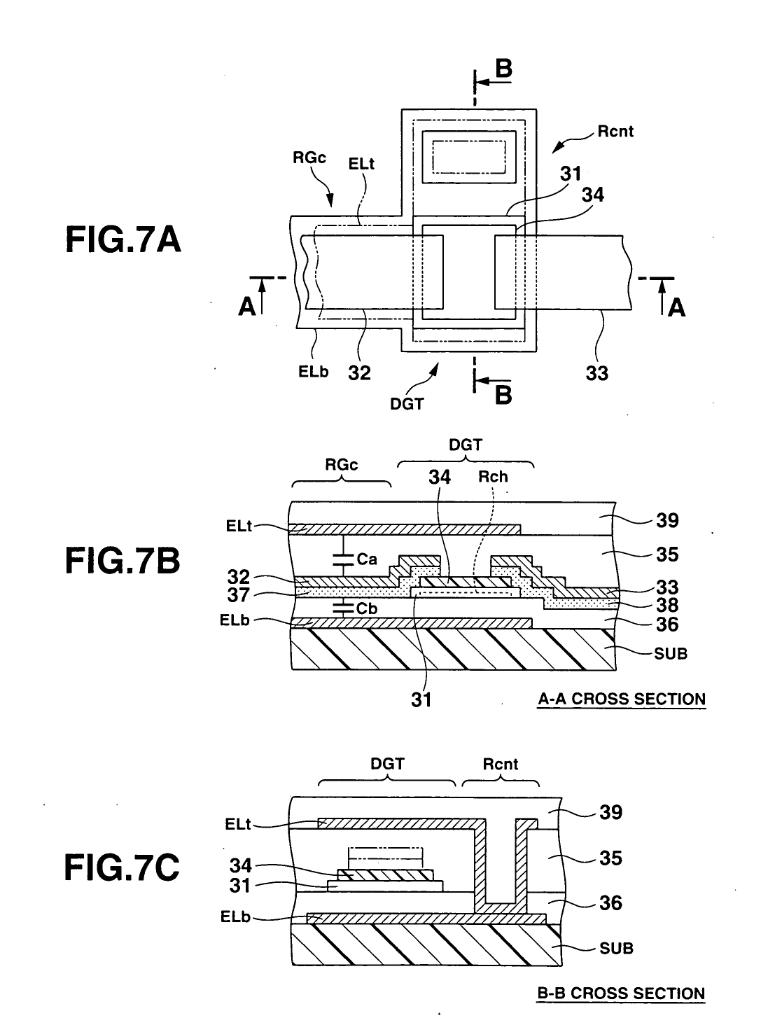

FIGS. 7A, 7B and 7C are schematic structural views showing an example of an element configuration when the double-gate type transistor according to this structural example is applied to the display pixel (the pixel drive circuit) according to each of the foregoing embodiments.

It is to be noted that, in FIGS. 7A, 7B and 7C, the top gate electrode in a plan structural view depicted in FIG. 7A is indicated by a two dots chain line and hatching in the cross-sectional structural views of FIGS. 7B and 7C is partially eliminated for the convenience's sake.

As shown in FIG. 6A, a double-gate type transistor DGT (Tr23 in FIG. 3) applied to the light emission drive transistor according to this embodiment generally has a semiconductor layer (a channel region) 31 formed of amorphous silicon or the like, a source electrode 32 (a source terminal S) and a drain electrode 33 (a drain terminal D) formed on both ends of the semiconductor layer 31 through impurity doped layers (ohmic contact layers) 37 and 38 respectively formed of n+ silicon. A top gate electrode ELt (a first gate electrode; the top gate terminal TG) is formed above (an upper part in the drawing) the semiconductor layer 31 through a block insulating film (an etching stopper film) 34 and a top gate insulating film 35. A bottom gate electrode ELb (a second gate electrode; the bottom gate terminal BG) is formed below (a lower part in the drawing) the semiconductor layer 31 through a bottom gate insulating film 36.

The double-gate type transistor DGT having such a configuration is, as shown in FIG. 6A, formed on an insulative substrate SUB such as a glass substrate. A protection insulating film 39 is formed in an entire region on one surface side of the insulative substrate SUB including the double-gate type transistor DGT. In the element configuration shown in FIG. 6A, the block insulating film 34 provided on the semiconductor layer 31 has a function as an etching stopper in an etching process when patterning the source electrode 32 and the drain electrode 33 provided on the semiconductor layer 31 as well as a function of avoiding a damage to the semiconductor layer 31 due to this etching.

Here, each of the top gate electrode ELt and the bottom gate electrode ELb constituting the double-gate type transistor DGT is formed of an electroconductive material such as an alloy of aluminum and titanium (aluminum-titanium), and each of the source electrode 32 and the drain electrode 33 is formed of an electroconductive material such as chrome or a chrome alloy. Further, each of the block insulating film 34, the top gate insulating film 35, the bottom gate insulating film 36 and the protection insulating film 39 is formed of an insulative material such as a silicon nitride film (SiN).

The double-gate type transistor having the configuration shown in FIG. 6A is generally represented by such an equivalent circuit as depicted in FIG. 6B.

In a case where the double-gate type transistor DGT is applied to the pixel drive circuits DCA (see FIG. 2) and DCB (see FIG. 3) of the above-described display pixels EMA and EMB, the top gate electrode ELt (the top gate terminal TG) and the bottom gate electrode ELb (the bottom gate terminal BG) are electrically connected (short-circuited), for example. In this case, in the element configuration of the double-gate type transistor DGT shown in FIG. 6A, for example, the extendingly formed top gate electrode ELt is configured to be electrically connected with the extendingly formed bottom gate electrode ELb via an opening portion (a contact hole) piercing the top gate insulating film 35 and the bottom gate insulating film 36 in a contact region Rcnt provided in the vicinity of a region where the double-gate type transistor DGT is formed as shown in FIGS. 7A and 7C.

Furthermore, the pixel drive circuits DCA (see FIG. 2) and DCB (see FIG. 3) have a configuration in which the capacitors C11 and C12 are connected between the gate and the source, in a capacitance region RGc provided in the vicinity of the region where the double-gate type transistor DGT is formed. Thus, a capacitance component Ca is formed by providing the extendingly formed top gate electrode ELt and source electrode 32 in an opposing (laminating) manner through the top gate insulating film 35 therebetween, and a capacitance component Cb is formed by providing the extendingly formed bottom gate electrode ELb and source electrode 32 in an opposing (laminating) manner through the bottom gate insulating film 36 therebetween, for example, as shown in FIGS. 7A and 7B.

Therefore, since capacitance values of the capacitors C11 and C12 respectively provided in the pixel drive circuits DCA and DCB correspond to a sum total of the capacitance components Ca and Cb formed in the same capacitance region RGc, a desired capacitance value can be realized in a narrower region (area) by applying the capacitance region RGc having such an element configuration.

A description will now be given as to element characteristics of the double-gate type transistor having the element configuration and the connection configuration mentioned above.

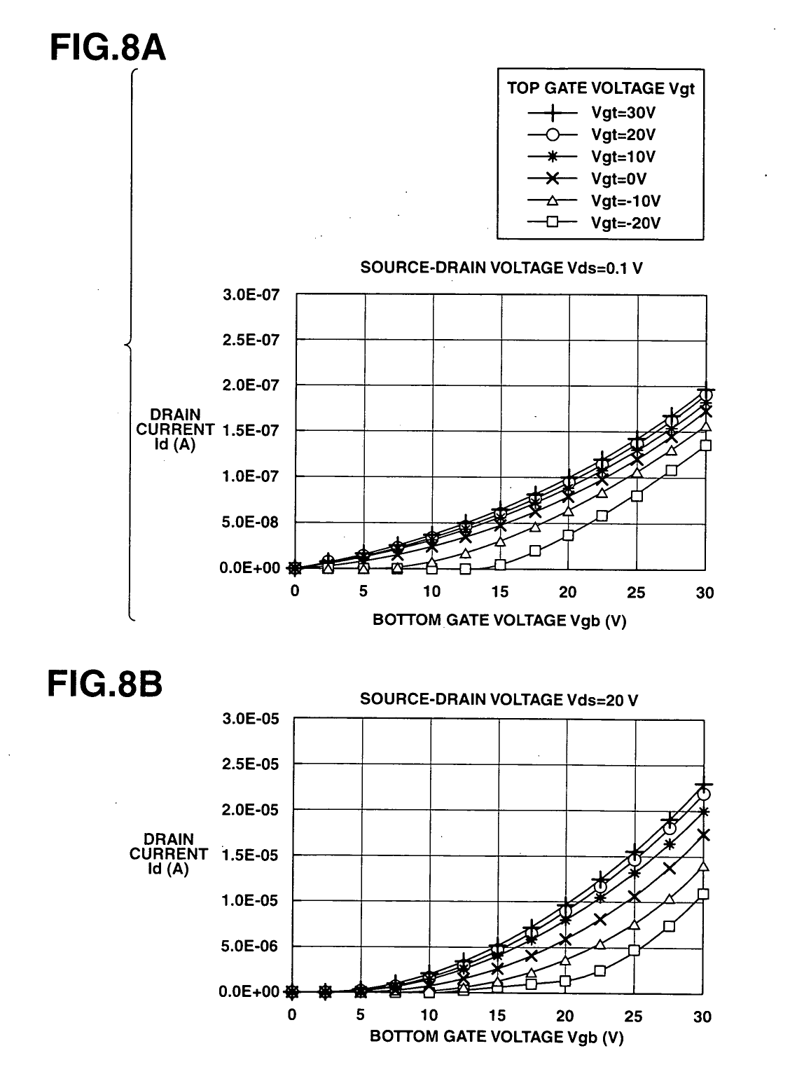

FIGS. 8A and 8B are views showing voltage-current characteristics (simulation results) in a state where the top gate terminal and the bottom gate terminal are electrically independent in the double-gate type transistor according to this structural example.

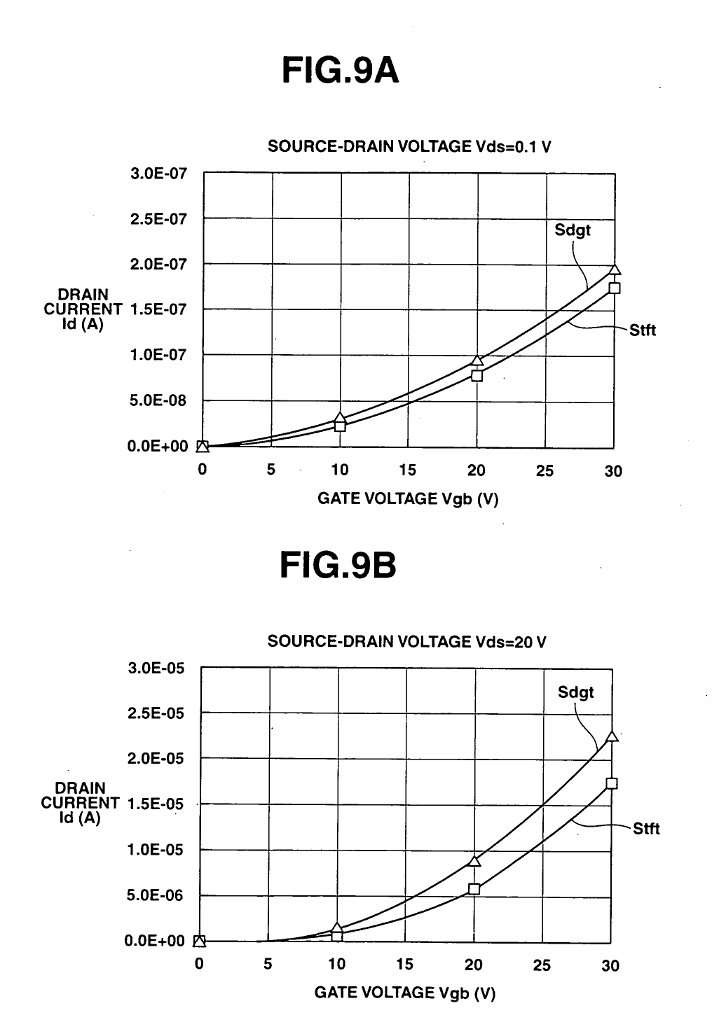

FIGS. 9A and 9B are views showing voltage-current characteristics (simulation results) in a state where the top gate terminal and the bottom gate terminal are electrically connected (short-circuited) in the double-gate type transistor according to this structural example.

First, in the double-gate type transistor DGT, a tendency of a change (the voltage-current characteristics) in a drain current (an ON current) with respect to a bottom gate voltage Vgb in the state where the top gate terminal and the bottom gate terminal are electrically independent (that is, the basic configuration of the double-gate type transistor shown in FIG. 6A) will be verified.

In the double-gate type transistor DGT in a state where the top gate terminal (the top gate electrode) and the bottom gate terminal (the bottom gate terminal) are electrically independent, when a potential difference (that is, a bias voltage) Vds between the source and drain terminals is relatively large (Vds=20 V), the tendency of a change in the drain current Id with respect to the bottom gate voltage Vgb is as shown in FIG. 8B. That is, it was observed that the drain current Id is considerably increased by applying a positive voltage (10 V→20 V→30 V) to the top gate voltage Vgt, and that the drain current Id is considerably decreased by applying a negative voltage (−10 V→−20 V) to the top gate voltage Vgt.

On the contrary, when the bias voltage Vds between the source and drain terminals is relatively small (Vds=0.1 V), the tendency of a change in the drain current Id with respect to the bottom gate voltage Vgb is as shown in FIG. 8A. That is, although the drain current Id is considerably decreased by applying a negative voltage (−10 V→−20 V) to the top gate voltage Vgt, a great increase in the drain current Id was not observed when a positive voltage (10 V→20 V→30 V) was applied to the top gate voltage Vgt.

It can be considered that this tendency occurs because, in the element configuration of the double-gate type transistor DGT shown in FIG. 6A, the source electrode 32 and the drain electrode 33 extendingly formed on the block insulating film 34 on the semiconductor layer 31 function as a pseudo top gate electrode with respect to the channel region formed in the semiconductor layer, and a contribution of the original top gate electrode ELt provided above the source electrode 32 and the drain electrode 33 to the channel region is restricted to a central part of the channel region where the source electrode 32 and the drain electrode 33 are not formed.

Furthermore, as another factor, a resistance distribution in the channel region can be also considered. That is, when the bias voltage Vds between the source and drain terminals is relatively small (a linear operation region), the resistance distribution in the channel region substantially uniformly shows a low-resistance state from the source side to the drain side. Therefore, in this state, even if a resistance value at the central part in the channel region is decreased by applying the top gate voltage, a drain current (an ON current) Id is not greatly increased, and hence it is considered that such voltage-current characteristics as shown in FIG. 8A can be obtained.

On the other hand, when the bias voltage Vds between the source and drain terminals is sufficiently large (a saturation operation region), the resistance distribution in the channel region shows a high-resistance state at the central part or in the vicinity of the drain side. Therefore, in this state, since the drain current (the ON current) Id is greatly increased by applying the top gate voltage to reduce the resistance value at the central part, it is considered that such voltage-current characteristics as shown in FIG. 8 are obtained.

In particular, in the display pixel EMB (the pixel drive circuit DCB) described in conjunction with the second embodiment, when the thin film transistor Tr21 is turned on, the gate electrode (the gate terminal) and the drain electrode (the driver terminal) of the double-gate type transistor Tr23 are short-circuited, and the display pixel operates in the saturation state. Therefore, as shown in FIG. 8B, the drain current Id can be considerably increased by controlling the top gate voltage Vgt. In other words, it is possible to greatly reduce an area of the transistor forming region required to obtain the drain current (the ON current) having a desired current value.

In FIGS. 8A and 8B, it can be considered that the voltage-current characteristics when the top gate voltage Vgt of the double-gate type transistor DGT is set to 0 V are equivalent to voltage-current characteristics of a general (known) field effect transistor having a single gate electrode since it can be conceived that the top gate voltage does not contribute to the channel region at all.

Moreover, it can be considered that the drain current with respect to the bottom gate voltage when the top gate voltage Vgt and the bottom gate voltage Vgb of the double-gate type transistor DGT are set to the same voltage value is equivalent to voltage-current characteristics when the top gate electrode and the bottom gate electrode are electrically connected (short-circuited).

Therefore, comparing the voltage-current characteristics in the thin film transistor having a single gate electrode and those in the double-gate type transistor DGT, like the example shown in FIGS. 8A and 8B, when the bias voltage Vds between the source and drain terminals is relatively large (Vds=20 V), a tendency of a change in the drain current Id with respect to the gate voltage (the bottom gate voltage) Vgb is as shown in FIG. 9B. That is, the drain current Id in the double-gate type transistor DGT is considerably increased. Moreover, even when the bias voltage Vds is relatively small (Vds=0.1 V), as shown in FIG. 9A, it was observed that the drain current Id in the double-gate type transistor DGT is slightly increased. In FIGS. 9A and 9B, reference symbol Stft denotes a characteristic line indicative of the voltage-current characteristics in the field effect transistor having a single gate electrode, and Sdgt designates a characteristic line indicative of the voltage-current characteristics in the double-gate type transistor in which the top and bottom gate electrodes according to this structural example are short-circuited.

Based on this, in the display pixels EMA and EMB according to the first and second embodiments shown in FIGS. 2 and 3, by applying the double-gate type transistor DGT having the element configuration in which the top gate electrode ELt and the bottom gate electrode ELb shown in FIG. 7C are short-circuited as the light emission drive transistor of the pixel drive circuits DCA and DCB, a larger drain current (a driving current) is allowed to flow through the organic EL element OEL with the same gate voltage even in the transistor configuration using an amorphous silicon semiconductor layer having a relatively low electron mobility.

In other words, even in the pixel drive circuit corresponding to a drive control method adopting either the voltage application mode or the current application mode, a transistor size (a gate width in particular) of the double-gate type transistor can be reduced in order to allow the same drain current (the driving current) to flow. Therefore, when an area of each display pixel forming region is fixed, an organic EL element forming area (a light emission region) can be relatively increased, thereby improving a numerical aperture of the display panel.

Further, since a gate voltage of the double-gate type transistor can be set low in order to allow the same drain current to flow, the pixel drive circuit having excellent operation characteristics (that is, the display panel having excellent display characteristics) can be realized while suppressing deterioration in transistor characteristics (the voltage-current characteristics) due to continuous application of a high voltage to the gate electrode, and power consumption involved by an image display operation can be suppressed. In this case, since a current density of the driving current flowing through the organic EL element can be reduced, deterioration in element characteristics of the organic EL element can be suppressed and a life duration can be increased.

A description will now be given as to an effect specific to an example where the double-gate type transistor according to this structural example is applied to the pixel drive circuit (that is, the pixel drive circuit corresponding to the current application mode; see FIG. 3) according to the second embodiment.

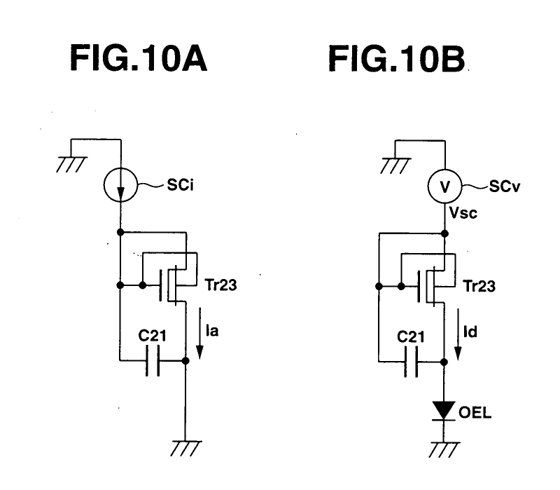

FIGS. 10A and 10B are circuit diagrams showing simulation models (simplified equivalent circuits) which are used to verify a write operation of the double-gate type transistor in the pixel drive circuit in the second embodiment.

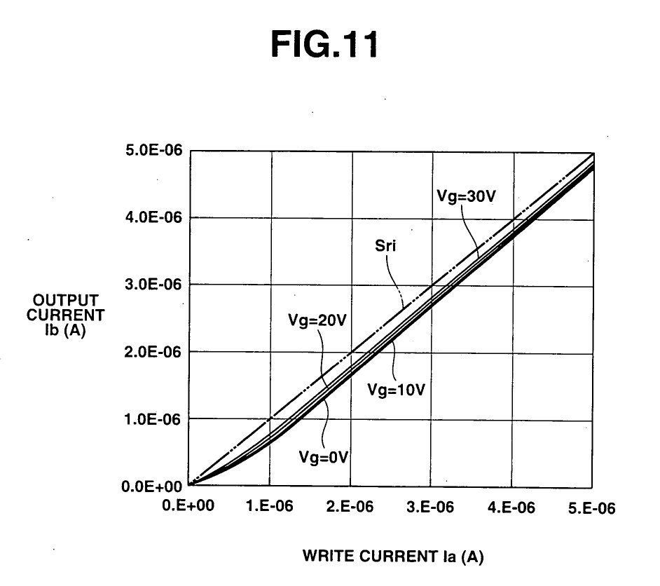

FIG. 11 is a characteristic view (a simulation result) showing a relationship (current characteristics) of a gradation signal current (an input current) and a driving current (an output current) when the double-gate type transistor according to this structural example is applied to the pixel drive circuit in the second embodiment.

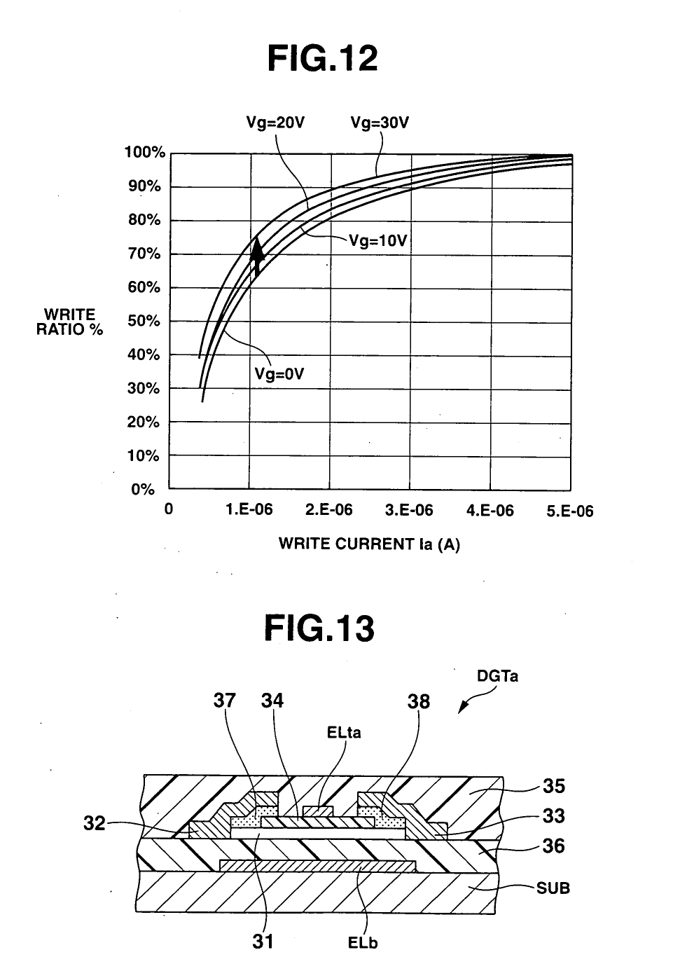

FIG. 12 is a characteristics view (a simulation result) showing a relationship between the gradation signal current (the input current) and a write ratio with respect to the pixel drive circuit when the double-gate type transistor according to this structural example is applied to the pixel drive circuit in the second embodiment.

In the display pixel EMB (the pixel drive circuit DCB) according to the second embodiment, a conductive state of each switching element (the thin film transistor Tr21 or Tr22, or the double-gate type transistor Tr23) in a write operation is as follows. That is, as shown in FIG. 4A, since the thin film transistor Tr22 and the double-gate type transistor Tr23 are turned on, paths from the data line DL from which the gradation signal current Ipix is supplied (drawn) to the thin film transistor Tr22, the contact point N22, the double-gate transistor Tr23 and the power supply line VL are connected as one, and the write current Ia flows from the power supply line VL in a direction of the data line DL through the pixel drive circuit DCB.

On the other hand, since the thin film transistor Tr21 is turned on, this state is equivalent to a state where the gate terminal (the top gate terminal and the bottom gate terminal) and the drain terminal of the double-gate type transistor Tr23 are connected.

Therefore, simplifying the circuit configuration of the display pixel EMB in the write operation state, as shown in FIG. 10A, generally, a current path is formed between a current supply source SCi for the write current Ia (corresponding to the gradation signal current Ipix) and a ground potential. This circuit configuration can be represented by an equivalent circuit including the double-gate type transistor Tr23 in which the top gate terminal, the bottom gate terminal and the drain terminal are short-circuited and the capacitor C21 connected between the gate and the source of the double-gate type transistor Tr23.

Furthermore, in the display pixel EMB (the pixel drive circuit DCB), a conductive state of each switching element (the thin film transistor Tr21 or Tr22, or the double-gate type transistor Tr23) in a light emitting operation is as follows. That is, as shown in FIG. 4B, since the thin film transistors Tr21 and Tr22 are turned off and the double-gate type transistor Tr23 continues the ON state, the paths from the power supply line VL to the double-gate type transistor Tr23, the contact point 22, the organic EL element OEL and the ground potential Vgnd are connected as one, and the driving current (an output current) Ib flows from the power supply line VL in a direction of the ground potential Vgnd through the pixel drive circuit DCB and the organic EL element OEL.

On the other hand, in this state, a high-level gate voltage is applied to the top gate terminal and the bottom gate terminal of the double-gate type transistor Tr23 due to electric charges held in the capacitor C21, the driving current Ib flows from the power supply line VL set at the high-level power supply voltage Vsc through the double-gate type transistor Tr23, whereby a potential of the contact point N21 (the gate voltage of the double-gate type transistor Tr23) is further increased to be substantially equal to the high level of the power supply line VL. Therefore, this state becomes equivalent to a state where the gate terminal (the top gate terminal and the bottom gate terminal; the contact point N21) and the drain terminal (the power supply line VL) of the double-gate type transistor Tr23 are connected.

Therefore, simplifying the circuit configuration of the display pixel EMB in the light emitting operation state, generally, as shown in FIG. 10B, a current path is formed between a voltage supply source SCv of the power supply voltage Vsc and the ground potential. This circuit configuration can be represented by an equivalent circuit including the double-gate type transistor Tr23 in which the top gate terminal, the bottom gate terminal and the drain terminal are short-circuited and the organic EL element OEL connected between the source terminal of the transistor Tr23 and the ground potential.

In such an equivalent circuit (a simulation model), the double-gate type transistor Tr23 was set to have a threshold voltage Vth=0 V, a channel length L=7 μm a capacity of the capacitor C21=20 pF, the write current Ia=50 μA, and a write time=80 μsec, and an analysis was carried out. As a result, as shown in FIG. 11, a simulation result showing substantial linearity was obtained. That is, a relationship (current characteristics) of a current value of the driving current (the output current) Ib supplied to the organic EL element OEL with respect to the write current Ia (≈the gradation current Ipix) fed to the display pixel EMB (the pixel drive circuit DCB) approximates a current characteristic line Sri indicative of an ideal write state in which the output current Ib having the same current value (having the same linearity) as that of the write current Ia is supplied to the organic EL element OEL as the gate voltage Vg applied to the top gate terminal and the bottom gate terminal of the double-gate type transistor Tr23 is increased (0 V→10 V→20 V→30 V), and non-linearity is improved.

Moreover, in this case, as shown in FIG. 12, as to a relationship (write characteristics) of the write ratio with respect to the write current Ia, there was obtained a simulation result indicative of a tendency in which the write ratio is considerably increased as the gate voltage Vg applied to the double-gate type transistor Tr23 is increased (0 V→10 V→20 V→30 V).

As described above in relation to the voltage-current characteristics, this is based on the fact that the gate voltage required to allow the same write current to flow can be reduced in the double-gate type transistor as compared with a general thin film transistor comprising a single gate electrode only, the write voltage which should be charged in the capacitor C21 connected between the gate and the source of the double-gate type transistor can be thereby reduced, and hence a time required for the write operation can be set short.

By applying the double-gate type transistor according to this structural example to the display pixel EMB (the pixel drive circuit DCB corresponding to the current application mode) in the second embodiment in this manner, a gate width of the double-gate transistor can be reduced and thus a numerical aperture can be improved with an improvement in the voltage-current characteristics. Moreover, the gate voltage can be reduced to suppress deterioration of the transistor characteristics or power consumption, and the linearity of the output current with respect to the write current and the write ratio with respect to the write current can be enhanced with an improvement in the current characteristics and the write characteristics. Therefore, image information can be displayed with an appropriate luminance gradation, thereby realizing the display apparatus superior in a display image quality.

In the first and second embodiments to which the double-gate type transistor according to this structural example is applied, although the description has been given as to the configuration in which the double-gate type transistor is applied to the light emission drive transistor (the switching element) alone which supplies the driving current to the organic EL element OEL as the optical element in the pixel drive circuits DCA and DCB, the present invention is not restricted thereto. For example, all the switching elements constituting the pixel drive circuit may include the double-gate type transistors.

In this case, since the light emission drive transistor is turned on in the saturation operation region because of its circuit configuration, the driving current (the drain current) with respect to the gate voltage can be increased based on the above-described voltage-current characteristics. However, since the thin film transistor other than the light emission drive transistor in the pixel drive circuit is turned on in a linear operation region, it is impossible to obtain an effect of considerably increasing the driving current based on the voltage-current characteristics. However, as compared with a general thin film transistor (a field effect transistor) which is not provided with a top gate but has a single gate electrode alone, the double-gate type transistor in which the opaque top gate electrode is provided on the semiconductor layer (the channel region) can obtain an effect of reducing a light-induced leak current due to external light which enters the channel region or an effect of blocking off an influence of an external electric field, thereby stably operating the pixel drive circuit (the display pixel) to realize an excellent display image.

FIG. 13 is a cross-sectional structural view showing another structural example of the element configuration of the double-gate type transistor according to this structural example.

Here, like reference numerals denote structures equivalent to those in the above-described structural example (see FIG. 6A), thereby simplifying their explanation.

In the first structural example, as the element configuration of the double-gate type transistor DGT, the source electrode 32 and the drain electrode 33 are formed to extend above the semiconductor layer 31, and the top gate electrode ELt having a shape corresponding to a two-dimensional spread of the semiconductor layer 31 is provided above the semiconductor layer 31, the source electrode 32 and the drain electrode 33 through the top gate insulating film 35, as shown in FIG. 6A. However, as described above, the source electrode 32 and the drain electrode 33 formed to extend on the end portions of the block insulating film 34 on the semiconductor layer 31 function as a pseudo top gate electrode with respect to the channel region formed in the semiconductor layer 31, and a substantial contribution of the top gate electrode ELt to the channel region is restricted to an area (the central part of the channel region) where the source electrode 32 and the drain electrode 33 are not formed. Therefore, as shown in FIG. 13, a top gate electrode ELta may be provided on a block insulating film 34 on a semiconductor layer 31 and in a region between a source electrode 32 and a drain electrode 33 (that is, above the central part of the channel region).

According to a double-gate type transistor DGTa having such a configuration, since the top gate electrode ELta is directly provided on the block insulating film 34 on the semiconductor layer 31 without using a top gate insulating film 35, a higher effect can be obtained with the same top gate voltage Vgt as that in the above-described structural example. Additionally, since the number of lamination layers in the lamination layer structure constituting the pixel drive circuit DCB can be reduced, the manufacturing process can be simplified to decrease the number of processes, thereby achieving an improvement in a process yield ratio or a reduction in a manufacturing cost.

### SECOND EMBODIMENT

A description will now be given as to a second structural example of the element configuration of the double-gate type transistor applied to the pixel drive circuit according to the present invention.

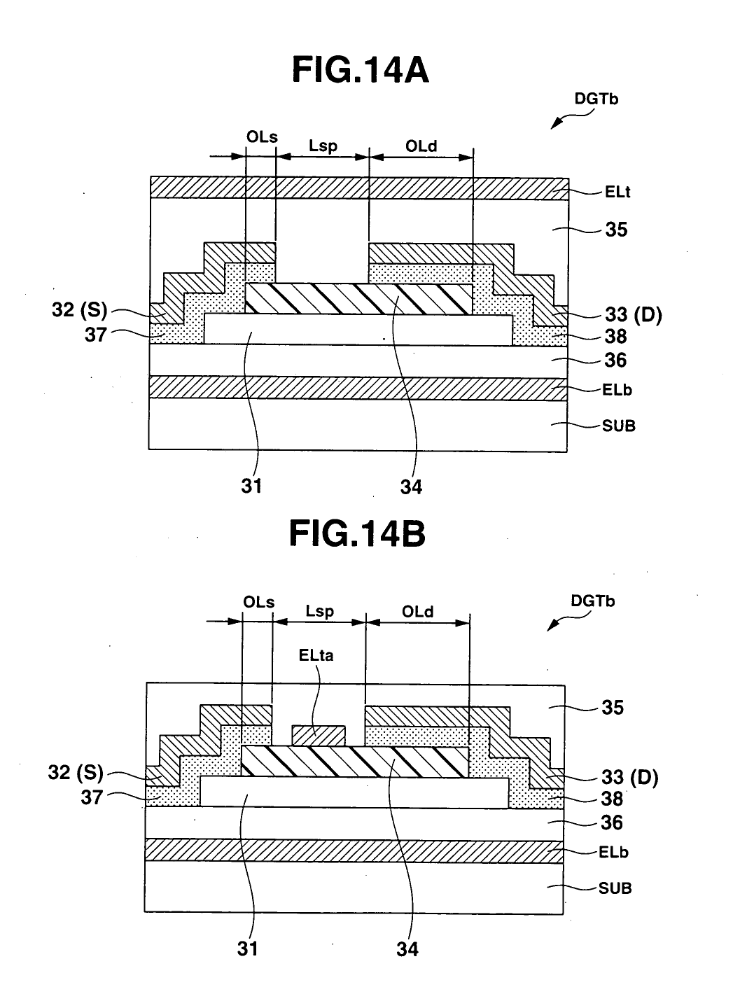

FIGS. 14A and 14B are a cross-sectional structural view and a circuit diagram showing a second structural example of the element configuration of the double-gate type transistor which is applied to the light emission drive transistor of the pixel drive circuit according to the present invention.

In the double-gate type transistor DGT according to the first structural example, the description has been given on the element configuration formed in such a manner that overlap dimensions of the source electrode 32 and the drain electrode 33 formed to extend on the block insulating film 34 on the semiconductor layer 31 with respect to the semiconductor layer 31 with the block insulating film 34 therebetween are substantially uniform (that is, symmetrical in the configurations shown in FIGS. 6A and 13). However, a double-gate type transistor DGTb according to this structural example has, as shown in FIGS. 14A and 14B, an element configuration in which overlap dimensions of a source electrode 32 and a drain electrode 33 with respect to a semiconductor layer 31 with a block insulating film 34 therebetween are different (that is, asymmetrical).

Specifically, for example, as shown in FIGS. 14A and 14B, in the double-gate type transistor DGTb, an overlap dimension or length OLs of the source electrode 32 on the block insulating film 34 is shorter than an overlap dimension or length OLd of the drain electrode 33 on the block insulating film (OLs<OLd), and a separation distance Lsp between the source electrode 32 and the drain electrode 33 is equal to a separation distance between the source electrode 32 and the drain electrode 33 in the configurations (FIGS. 6A and 13) of the first structural example. That is, in the display pixel EMB (the pixel drive circuit DCB), the overlap dimension of the electrode on the block insulating film 34 on the side where a driving current (an output current) Ib flows to an optical element (an organic EL element OEL) is formed to be relatively short.

Element characteristics of the double-gate type transistor having the above-described element configuration will now be explained.

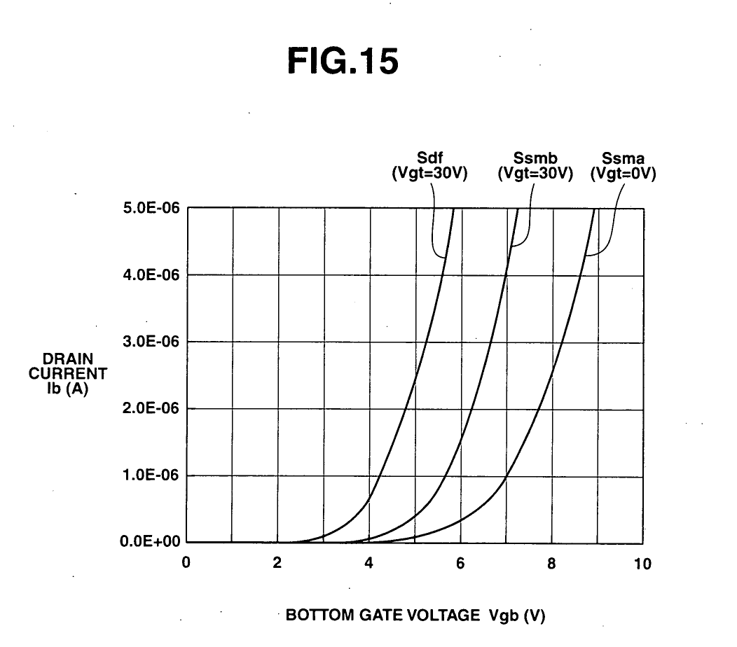

FIG. 15 is a view showing voltage-current characteristics (a simulation result) in a state where a top gate terminal and a bottom gate terminal are electrically independent in the double-gate type transistor according to this structural example.

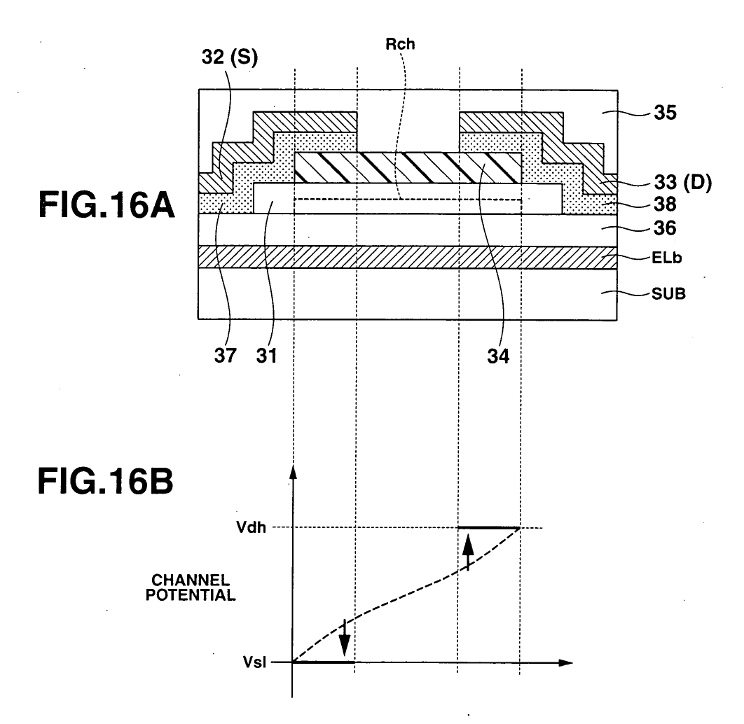

FIGS. 16A and 16B are views illustrating voltage-current characteristics when the double-gate type transistor according to this structural example is applied to the pixel drive circuit in the second embodiment.

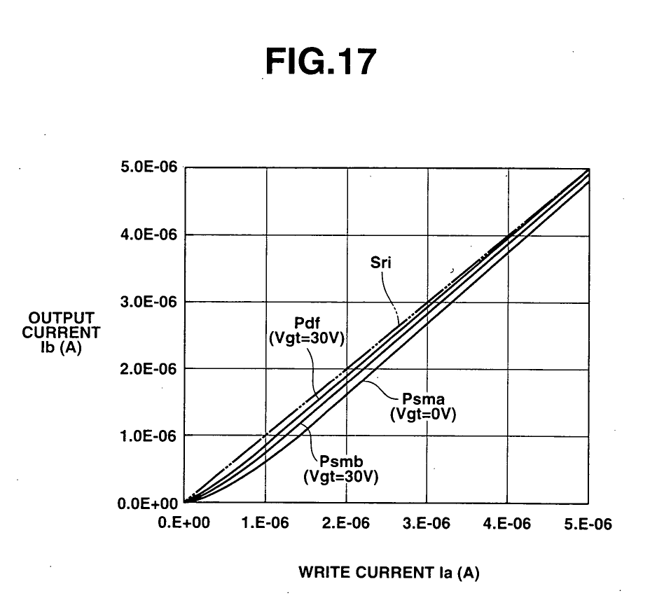

FIG. 17 is a characteristic view (a simulation result) showing a relationship (current characteristics) between a gradation signal current (an input current) and a driving current (an output current) when the double-gate type transistor according to this structural example is applied to the pixel drive circuit in the second embodiment.

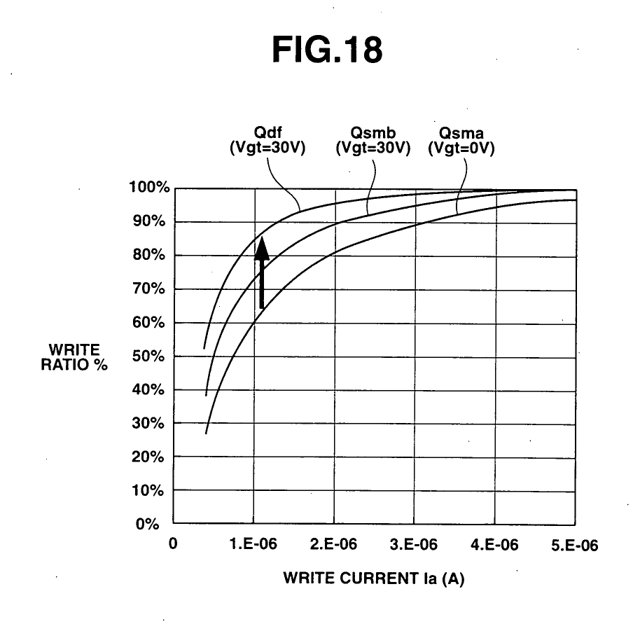

FIG. 18 is a characteristic view (a simulation result) showing a relationship between the gradation signal current (the input current) and a write ratio with respect to the pixel drive circuit when the double-gate type transistor according to this structural example is applied to the pixel drive circuit in the second embodiment.

First, in the double-gate type transistor DGTb according to this embodiment, a tendency of a change (voltage-current characteristics) in a drain current (an ON current) Id with respect to a bottom gate voltage Vgb in a state where a top gate terminal TG and a bottom gate terminal BG are electrically independent will be verified.

Here, an observation was performed in a case where a length of the block insulating film 34 on the semiconductor layer 32 in a source-drain direction (a right-and-left direction in FIGS. 14A and 14B) is, e.g., 7 μm and respective overlap dimensions of the source electrode 32 and the drain electrode 33 on the block insulating film 34 are set to, e.g., 1 μm and 3 μm as the element configuration of the double-gate type transistor which is a target of verification. It is to be noted that, as a comparison target, an observation was likewise performed in a case where respective overlap dimensions of the source electrode 32 and the drain electrode 33 on the block insulating film 34 are both set to, e.g., 2 μm

In the double-gate type transistor DGTb according to this structural example, observing voltage-current characteristics in a state where the top gate terminal (the top gate electrode) and the bottom gate terminal (the bottom gate electrode) are electrically independent, as shown in FIG. 15, it was revealed that the tendency of a change in the drain current Id with respect to the bottom gate voltage Vgb can be considerably improved in the element configuration where the overlap dimensions of the source electrode 32 and the drain electrode 33 on the block insulating film 34 are formed to be different from each other as compared with the element configuration where the overlap dimensions of the source electrode 32 and the drain electrode 33 on the block insulating film 34 are formed to be equal to each other (that is, the double-gate type transistor DGT described in the first structural example). In FIG. 15, reference symbol Ssma denotes a characteristics line indicative of the voltage-current characteristics in a state where the top gate voltage is not applied (Vgt=0 V) in the double-gate type transistor having the element configuration in which the overlap dimensions of the source electrode and the drain electrode on the block insulating film are formed to be equal to each other; Ssmb, a characteristic line indicative of the voltage-current characteristics in a state where the top gate voltage is applied (Vgt=30 V) in the double-gate type transistor having the element configuration in which the overlap dimensions of the source electrode and the drain electrode on the block insulating film are formed to be equal to each other; and Sdf, a characteristic line indicative of the voltage-current characteristics in a state where the top gate voltage is applied (Vgt=30 V) in the double-gate type transistor having the element configuration according to this structural example in which the overlap dimensions of the source electrode and the drain electrode on the block insulating film are formed be different from each other.

It can be explained that this improvement is possible because of the fact that the source electrode 32 and the drain electrode 33 are provided to extend on the block insulating film 34 on the semiconductor layer 31 like the above-described example and these electrodes thereby function as a pseudo top gate electrode in such a thin film transistor configuration (that is, an element configuration in which the top gate electrode ELt of the double-gate type transistor DGT is eliminated, or a state where the gate voltage Vgt is not applied to the top gate terminal TG in the double-gate type transistor DGT) as shown in FIG. 16A.

That is, in the transistor having the element configuration shown in FIG. 16A, in a region where the source electrode 32 and the drain electrode 33 overlap the semiconductor layer 31 through the block insulating film 34, a channel region is formed in the semiconductor layer by the voltage applied to these electrodes, and a channel region as well as an original channel region (that is, a channel region formed at a substantially central part of the semiconductor layer 31 by the top gate voltage Vgt) formed in a region where the source electrode 32 and the drain electrode 33 are not formed is also formed in regions corresponding to the source electrode 32 and the drain electrode 33. As a result, a channel region Rch is formed in the semiconductor layer 31 in a region extending from the source electrode 32 to the drain electrode 33 where the block insulating film 34 is formed. At this time, a change in a potential corresponding to a bias voltage (a source voltage and a drain voltage) applied between the source and drain terminals is generated in the channel region.

Here, as shown in FIG. 16B, when a predetermined bias voltage is applied between the source and drain terminals and a low-potential voltage Vsl is applied to the source electrode 32 whilst a high-potential voltage Vdh is applied to the drain electrode 33, there is a function of reducing a channel potential on the source electrode 32 side to which the low-potential voltage Vsl is applied, i.e., converging on (approximating) the voltage Vsl. Therefore, an ON current (the drain current) is suppressed. On the other hand, since there is a function of increasing a channel potential on the drain electrode 33 side to which the high-potential voltage Vdh is applied, i.e., converging on (approximating) the voltage Vdh, the ON current is increased. It is to be noted that a broken line in FIG. 6 indicates an ideal value of a change in the potential in the channel region.

In the double-gate type transistor DGT described in the first structural example, since the overlap dimensions of the source electrode 32 and the drain electrode 33 in the channel region (the block insulating film 34) are formed to be equal to each other, the effects of reducing and increasing the channel potential shown in FIG. 16B are equal to each other and balanced. However, in the double-gate type transistor DGTb according to this structural example, the overlapping parts of the source electrode 32 and the drain electrodes 33 in the channel region (the block insulating film 34) are different from each other. When the overlap dimension on the drain electrode 33 side is larger than that of the source electrode 32 side, a change in the potential in the channel region is biased toward the high-potential side, and there is a function of increasing the drain current Id.

Based on this, in the display pixels EMA and EMB according to the first and second embodiments shown in FIGS. 2 and 3, when the double-gate type transistor having the element configuration in which the overlap dimensions of the source electrode and the drain electrode in the channel region (the block insulating film 34) are formed to be asymmetrical is applied as the light emission drive transistor of the pixel drive circuits DCA and DCB as shown in FIGS. 14A and 14B, the voltage-current characteristics can be improved. Further, even in a transistor configuration using an amorphous silicon semiconductor layer whose electron mobility is relatively low, a larger drain current (the driving current) is allowed to flow through the organic EL element OEL with the same gate voltage.

That is, since the gate voltage which should be applied to allow the same drain current to flow can be set low, a transistor size (a gate width in particular) of the double-gate type transistor can be reduced, and thus an organic EL element forming area (a light emission region) in a region where each display pixel is formed can be relatively increased to improve a numerical aperture of the display panel. Furthermore, deterioration in transistor characteristics (the voltage-current characteristics) caused due to an application of a high voltage to the gate electrode can be suppressed, thereby realizing the pixel drive circuit having excellent operating characteristics (that is, the display panel having excellent display characteristics).

Moreover, when the top gate terminal and the bottom gate terminal are electrically connected (short-circuited) in the double-gate type transistor DGTb according to this structural example and this transistor is applied to the light emission drive transistor Tr23 of the display pixel EMB (the pixel drive circuit DCB) according to the second embodiment, current characteristics in the write operation and the light emitting operation were verified by using the simulation models shown in FIGS. 10A and 10B (various setting conditions are the same as those in the first structural example). As shown in FIG. 17, the following simulation result was obtained. That is, in regard to a relationship of a current value of the driving current (the output current) Ib supplied to the organic EL element with respect to the write current Ia (≈the gradation current Ipix) to the display pixel EMB (the pixel drive circuit DCB), the current value of the output current Ib with respect to the write current Ia further approximates ideal current characteristics (a characteristic line Sri) indicative of linearity and non-linearity is further improved in the example where the overlap dimensions of the source electrode 32 and the drain electrode 33 on the block insulating film 34 are asymmetrically set to the element configuration (FIGS. 14A and 14B) applied to the double-gate type transistor Tr23 as compared with the example where the overlap dimensions are set to be equal to each other.

In FIG. 17, reference symbol Psma denotes a characteristic line indicative of current characteristics in a state where the top gate voltage is not applied (Vgt=0 V) in the double-gate type transistor having the element configuration formed in such a manner that the overlap dimensions of the source electrode and the drain electrode on the block insulating film are equal to each other; Psmb, a characteristic line indicative of current characteristics in a state where the top gate voltage is applied (Vgt=30 V) in the double-gate type transistor having the element configuration formed in such a manner that the overlap dimensions of the source electrode and the drain electrode on the block insulating film are equal to each other; and Pdf, a characteristic line indicative of current characteristics in a state where the top gate voltage is applied (Vgt=30 V) in the double-gate type transistor having the element configuration according to this structural example formed in such a manner that the overlap dimensions of the source electrode and the drain electrode on the block insulating film are different from each other.

Moreover, in this case, as shown in FIG. 18, as to a relationship (write characteristics) of the write ratio to the write current Ia, a simulation result indicative of a tendency that the write ratio is considerably increased was obtained in the case where the overlap dimensions of the source electrode 32 and the drain electrode 33 on the block insulating film 34 are set asymmetrical.

In FIG. 18, reference symbol Qsma denotes a characteristic line indicative of write characteristics in a state where the top gate voltage is not applied (Vgt=0 V) in the double-gate type transistor having the element configuration formed in such a manner that the overlap dimensions of the source electrode and the drain electrode on the block insulating film are equal to each other; Qsmb, a characteristic line indicative of write characteristics in a state where the top gate voltage is applied (Vgt=30 V) in the double-gate type transistor having the element configuration formed in such a manner that the overlap dimensions of the source electrode and the drain electrode on the block insulating film are equal to each other; and Qdf, a characteristic line indicative of write characteristics in a state where the top gate voltage is applied in the double-gate type transistor having the element configuration according to this embodiment formed in such a manner that the overlap dimensions of the source electrode and the drain electrode on the block insulating film are different from each other.

By applying the double-gate type transistor according to this structural example to such a display pixel EMB (the pixel drive circuit DCB corresponding to the current application mode) as described in the second embodiment in this manner, a gate width of the double-gate type transistor can be reduced to improve a numerical aperture of the display panel with an improvement in the voltage-current characteristics. Additionally, the gate voltage can be reduced to suppress deterioration in the transistor characteristics or power consumption, and the linearity of the output current with respect to the write current and the write ratio with respect to the write current can be enhanced with a considerable improvement in the current characteristics and the write characteristics. Therefore, image information can be displayed with an appropriate luminance gradation, thereby realizing the display apparatus having a further excellent display image quality.

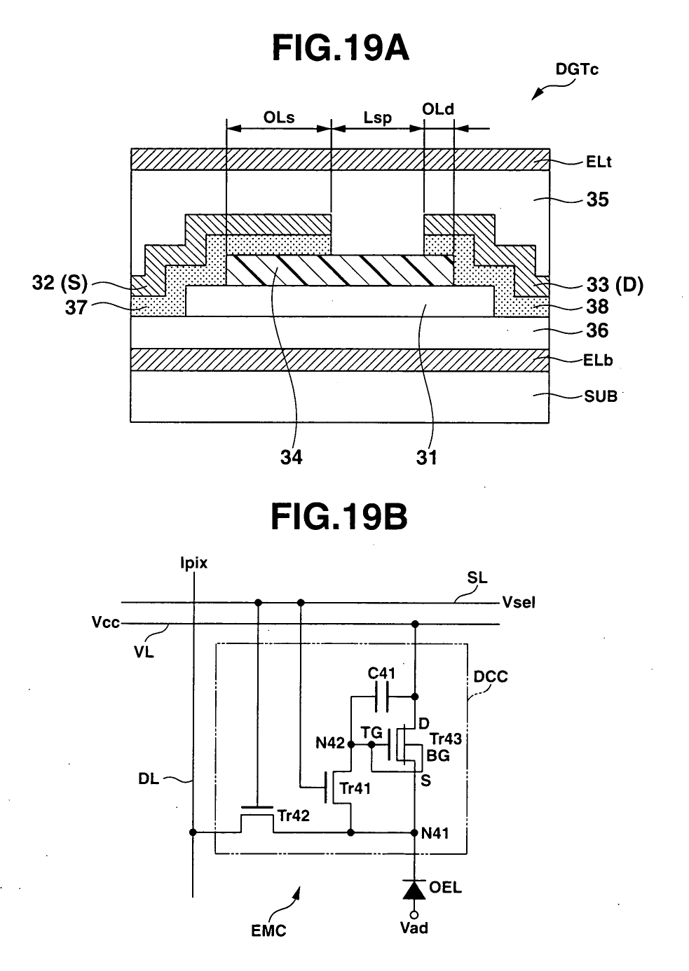

FIGS. 19A and 19B are views showing another structural example of the element configuration of the double-gate type transistor according to this structural example, and another circuit configuration example when this double-gate type transistor is applied to the pixel drive circuit (the display pixel) corresponding to the current application mode. Here, like reference numerals denote the same structures as the element configurations (FIGS. 14A and 14B) of the double-gate type transistor and the display pixel (the pixel drive circuit; FIG. 3), thereby simplifying their explanation.

The above description has been given as to the double-gate type transistor DGTb according to the second structural example. That is, as shown in FIGS. 14A and 14B, the overlap dimension OLd of the drain electrode 33 on the block insulating film 34 is set larger than the overlap dimension OLs of the source electrode 32 on the block insulating film 34, and the bias state is set so that the high-potential voltage is applied to the drain electrode 33 (the drain terminal D) and the low-potential voltage is applied to the source electrode 32 (the source terminal S). As a result, the driving current Ib (the drain current Id) flowing through the organic EL element (the optical element) OEL through the source electrode 32 can be increased (the voltage-current characteristics can be improved). However, when the bias voltages applied to the drain electrode 33 (the drain terminal D) and the source electrode 32 (the source terminal S) are set to have polarities opposite to each other, it is possible to apply a double-gate type transistor DGTc having an element configuration in which the overlap dimension OLd on the drain electrode side is set smaller than the overlap dimension OLs on the source electrode side as shown in FIG. 19A.

It is to be noted that, as shown in FIG. 19B, the double-gate type transistor DGTc (Tr43) having the element configuration in which a negative driving current (the drain current) is supplied (drawn) to the organic EL element (the optical element) OEL in a bias state where a high-potential voltage is applied to the source electrode 32 (the source terminal S) whilst a low-potential voltage is applied to the drain electrode 33 (the drain terminal D) can be excellently applied to, e.g., a display pixel EMC including a pixel drive circuit DCC and an organic EL element (an optical element) OEL having a cathode terminal connected to a contact point N41 of the pixel drive circuit DCC and an anode terminal connected with a ground potential. The pixel drive circuit DCC comprises a thin film transistor Tr42 having a gate terminal connected with a scanning line SL and source and drain terminals respectively connected with a data line DL and a contact point N41, a thin film transistor Tr41 having a gate terminal connected with the scanning line SL and source and drain terminals respectively connected with the contact point N42 and a contact point N41, a double-gate type transistor Tr43 (corresponding to the double-gate type transistor DGTc according to this structural example) having a gate terminal connected with the contact point N42, a drain terminal connected with a power supply line VL and a source terminal connected with the contact point N41, and a capacitor C41 connected between the contact point N42 and the power supply line VL. Here, the double-gate type transistor Tr43 is connected in such a manner that a top gate terminal TG and a bottom gate terminal BG are electrically short-circuited.

In such a display pixel EMC (the pixel drive circuit DCC), a write current Ia flows in a direction of the power supply line VL from the data line DL side through the pixel drive circuit DCC (the thin film transistor Tr42, the contact point N41 and the double-gate type transistor Tr43) at the time of an operation of writing a gradation signal current Ipix from the data driver 130 as opposite to the operating state shown in FIG. 4A. On the other hand, in a light emitting operation in the display pixel EMC, a driving current Ib flows in the direction of the power supply line VL from the organic EL element OEL side through the pixel drive circuit DCC (the contact point N41 and the double-gate type transistor Tr43) as opposite to the operating state shown in FIG. 4B.

In this case, by applying such a double-gate type transistor having an element configuration in which overlap dimensions of a source electrode and a drain electrode on a block insulating film (a channel region) are different from each other as shown in FIG. 19A as the light emission drive transistor, voltage-current characteristics can be improved and a transistor size (a gate width) of the double-gate type transistor can be reduced like the above example. Therefore, a numerical aperture of the display panel 110 can be improved, and a gate voltage can be reduced to suppress deterioration in transistor characteristics or power consumption. Additionally, current characteristics and write characteristics can be considerably improved, thereby realizing the display apparatus having an excellent display image quality.

When the double-gate type transistor according to this structural example is applied to such a display pixel EMB (the pixel drive circuit DCB corresponding to the current application mode) as described in conjunction with the second embodiment in this manner, the gate width of the double-gate type transistor can be reduced to improve the numerical aperture with the improvement in the voltage-current characteristics. Further, the gate voltage can be reduced to suppress deterioration in the transistor characteristics or power consumption, and linearity of an output current with respect to a write current and a write ratio with respect to the write current can be enhanced with the improvement in the current characteristics and the write characteristics. Therefore, image information can be displayed with an appropriate luminance gradation, thereby realizing the display apparatus having an excellent display image quality.

### THIRD STRUCTURAL EXAMPLE

A description will now be given as to a third structural example of the element configuration of the double-gate type transistor applied to the pixel drive circuit according to the present invention with reference to the accompanying drawings.

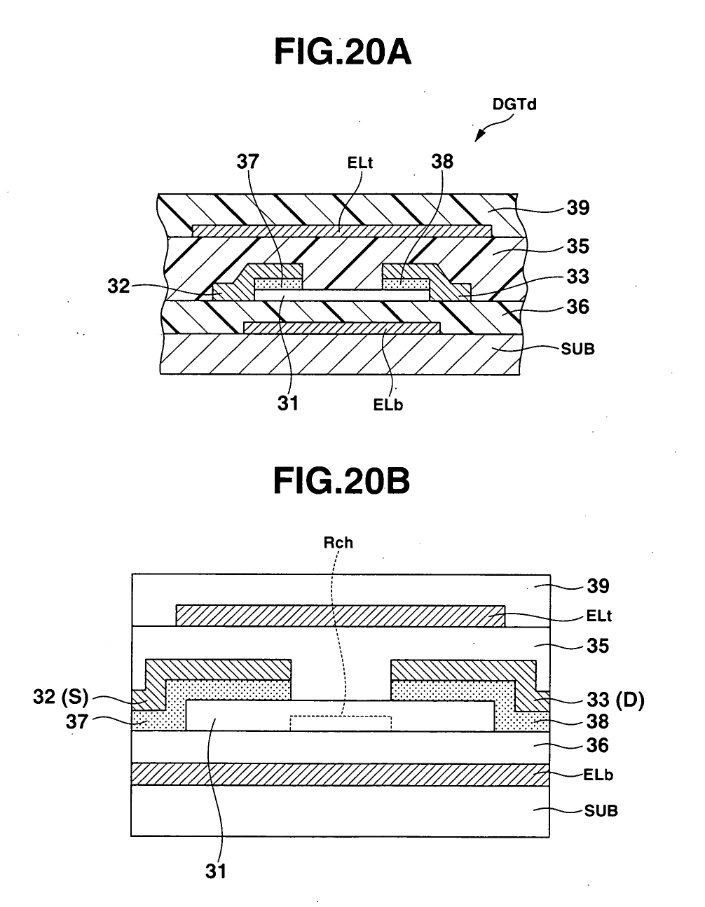

FIGS. 20A and 20B are cross-sectional structural views showing a third structural example of the element configuration of the double-gate type transistor applied to the light emission drive transistor of the pixel drive circuit according to the present invention.

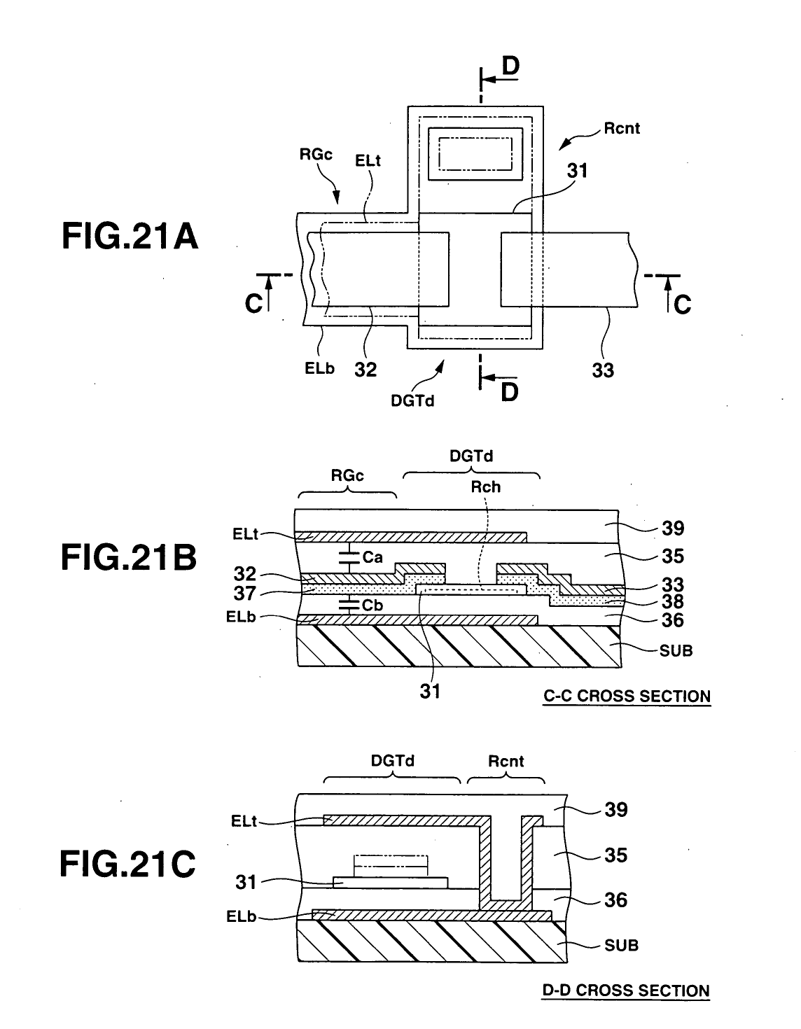

FIGS. 21A, 21B and 21C are schematic structural views showing an example of the element configuration when the double-gate type transistor according to this structural example is applied to the display pixel (the pixel drive circuit) according to each of the foregoing embodiments.

In FIG. 21A, a top gate electrode in the plan structural view of FIG. 7A is indicated by a two-dots chain line, and the hatching in the cross-sectional structural views of FIGS. 21B and 21C is partially eliminated for the convenience's sake. Further, like reference numerals denote structures equal to those in each of the foregoing embodiments, thereby simplifying a description thereof.

In the double-gate type transistors DGT and DGTa to DGTc according to the first and second structural examples, the description has been given as to the element configuration in which the source electrode 32 and the drain electrode 33 are formed to extend on the block insulating film 34 on the semiconductor layer 31. However, the double-gate type transistor DGTd according to this structural example has, as shown in FIG. 20A, an element configuration in which a source electrode 32 (a source terminal S) and a drain electrode 33 (a drain terminal D) are formed at both end regions of a semiconductor layer (a channel region) 31 through impurity doped layers (ohmic contact layers) 37 and 38 which are directly formed on the semiconductor layer 31 and made of n⁺-silicon. That is, the element configuration of the double-gate type transistor according to the first structural example shown in FIG. 6A has a structure in which the block insulating film 34 formed on the semiconductor layer 31 is eliminated.

Furthermore, in a case where the double-gate type transistor DGTd having such a configuration is applied to the pixel drive circuits DCA (see FIG. 2) and DCB (see FIG. 3) of the display pixels EMA and EMB, the double-gate type transistor has a configuration in which a top gate electrode ELt (a top gate terminal TG) and a bottom gate electrode ELb (a bottom gate terminal BG) are electrically connected (short-circuited). Therefore, like the double-gate type transistor DGT according to the first structural example, the extendingly formed top gate electrode ELt is electrically connected with the extendingly formed bottom gate electrode ELb via an opening portion (a contact hole) piercing a top gate insulating film 35 and a bottom gate insulating film 36 in a contact region Rcnt provided in the vicinity of a region where the double-gate type transistor DGTd is formed as shown in FIGS. 21A and 21C, for example.

Further, in the pixel drive circuits DCA (see FIG. 2) and DCB (see FIG. 3), the capacitors C11 and C12 each of which is connected between the gate and the source have the following configuration. For example, as shown in FIGS. 21A and 21B, in a capacitance region RGc provided in the vicinity of the region where the double-gate type transistor DGTd is formed, a capacitance component Ca is formed when the top gate electrode Elt and the source electrode 32 which are extendingly formed face each other with a part of the top gate insulating film 35 provided therebetween, and a capacitance component Cb is formed when the bottom gate electrode ELb and the source electrode 32 which are extendingly formed face each other with a part of the bottom gate insulating film 36 therebetween. Furthermore, a sum total of these capacitance components Ca and Cb becomes a capacitance value of the respective capacitors C11 and C12.

A description will now be given as to element characteristics of the double-gate type transistor having the above-described element configuration and connection structure.

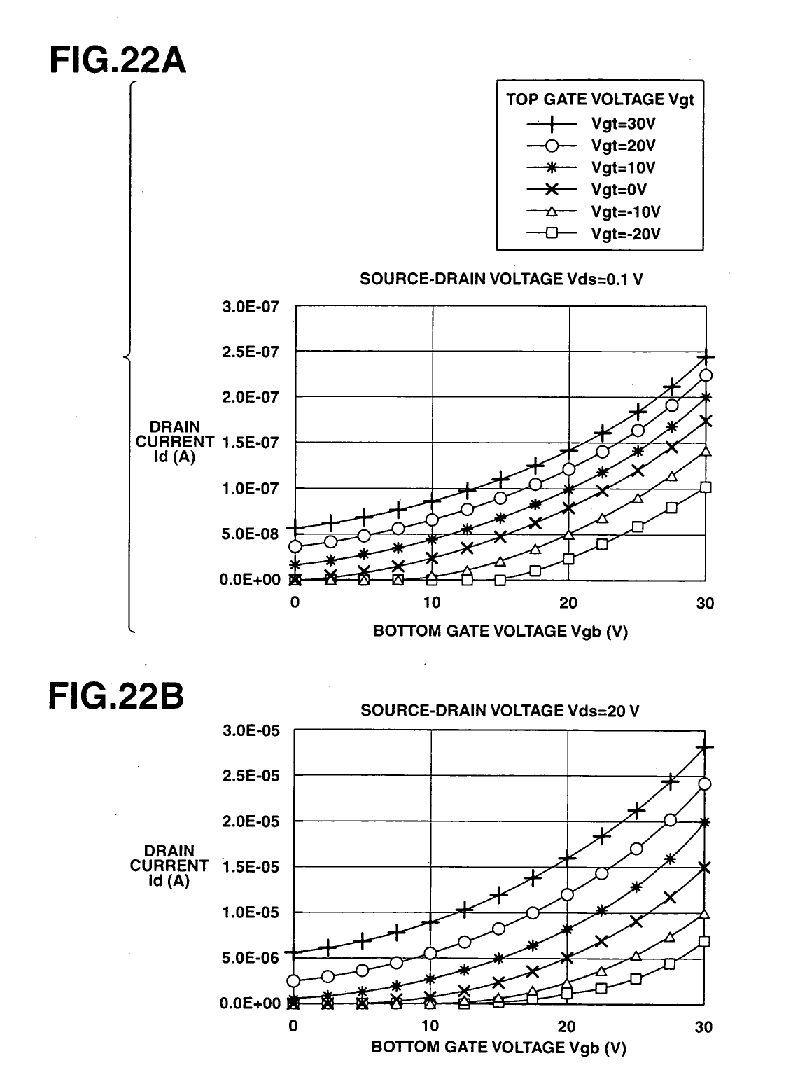

FIGS. 22A and 22B are views showing voltage-current characteristics (simulation results) in a state where the top gate terminal and the bottom gate terminal are electrically independent in the double-gate type transistor according to this structural example.

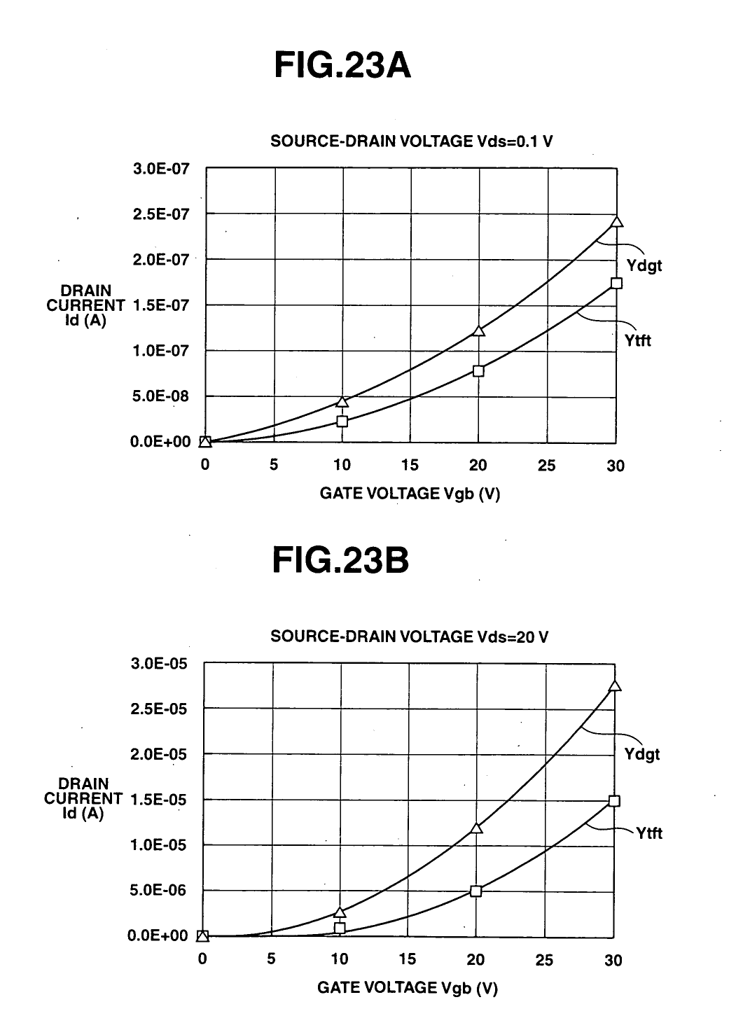

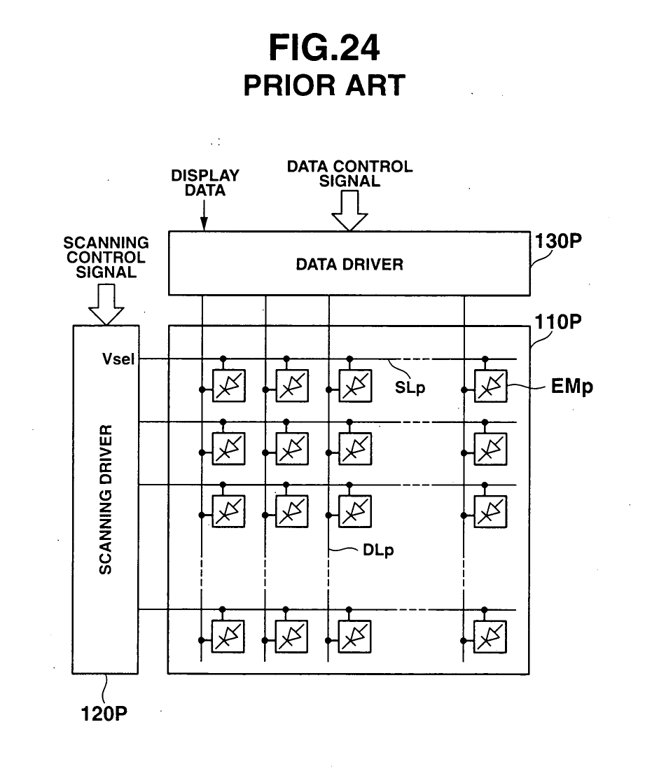

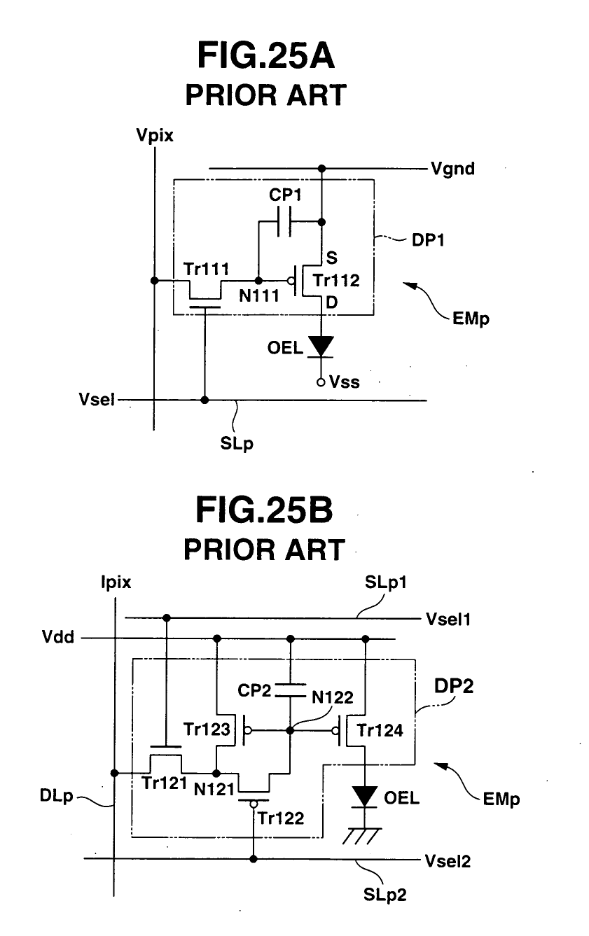

FIGS. 23A and 23B are views showing voltage-current characteristics (simulation results) in a state where the top gate terminal and the bottom gate terminal are electrically connected (short-circuited) in the double-gate type transistor according to this structural example.

First, in the above-described double-gate type transistor DGT, a verification will be performed about a tendency of a change in a drain current (an ON current) Id with respect to a bottom gate voltage Vgb in a state where the top gate terminal and the bottom gate terminal are electrically independent. As shown in FIGS. 22A and 22B, the tendency of a change in the drain current Id with respect to the bottom gate voltage Vgb is as follows. It was observed that, even if a potential difference Vds between the source and drain terminals (that is, a bias voltage) is relatively large (Vds=20 V) or relatively small (Vds=0.1 V), the drain current Id tends to increase when a positive voltage (10 V→20 V→30 V) is applied to the top gate voltage and the drain current Id tends to considerably decrease when a negative voltage (−10 V→−20 V) is applied to the top gate voltage Vgt as compared with the element characteristics (see FIGS. 8A and 8B) of the double-gate type transistor according to the first structural example. In particular, it was revealed that the drain current Id remarkably increases when a positive voltage is applied to the top gate voltage Vgt.

It can be considered that this tendency is observed because, in the double-gate type transistor DGTd according to this structural example, the block insulating film 34 is not interposed between the semiconductor layer 31 and the source and drain electrodes 32 and 33 as different from the element configuration of the double-gate type transistor DGT shown in FIG. 6A, and hence a function as the pseudo top gate electrode cannot be obtained. Moreover, as shown in FIG. 20B, a channel region Rch is formed only in the semiconductor layer 31 in a region where the source electrode 32 and the drain electrode 33 are not extendingly formed, whereby an influence of the gate voltage Vgt applied to the top gate electrode ELt on the channel region Rch is not obstructed.

Additionally, in FIGS. 22A and 23B, it can be considered that the voltage-current characteristics when the top gate voltage Vgt of the double-gate type transistor DGTd is set to 0 V are equal to the voltage-current characteristics in a general field effect transistor (a thin film transistor) comprising a single gate electrode alone. Therefore, comparing the voltage-current characteristics in such a general field effect transistor with the voltage-current characteristics in the element configuration (FIGS. 21A and 21C) in which the top gate terminal is electrically connected with the bottom gate terminal in the double-gate type transistor DGTd according to this structural example, a tendency of a change in the drain current Id with respect to the gate voltage (the bottom gate voltage) Vgb is as follows irrespective of an intensity of the bias voltage Vds between the source and drain terminals like the example shown in FIGS. 9A and 9B. That is, as shown in FIGS. 23A and 23B, it was observed that the drain current Id considerably increases in the double-gate type transistor DGT. It is to be noted that, in FIGS. 23A and 23B, reference symbol Ytft denotes a characteristic line indicative of voltage-current characteristics in the field effect transistor including a single gate electrode, and Ydgt designates a characteristic line indicative of voltage-current characteristics in the double-gate type transistor according to this structural example in which the top gate electrode and the bottom gate electrode are short-circuited.

Based on this, in the display pixels EMA and EMB according to the first and second embodiments shown in FIGS. 2 and 3, when such a double-gate type transistor DGTd as show in FIGS. 21A and 21C which has the element configuration in which the top gate electrode ELt and the bottom gate electrode ELb are short-circuited is applied as the light emission drive transistor of the pixel drive circuits DCA and DCB, a larger drain current (a driving current) can be allowed to flow through the organic EL element OEL with the same gate voltage even in a transistor configuration using an amorphous silicon semiconductor layer whose electron mobility is relatively low.

Therefore, even in the pixel drive circuit corresponding to the drive control method adopting either the voltage application mode or the current application mode, since a transistor size (a gate width in particular) of the double-gate type transistor can be reduced in order to allow the same drain current (a driving current) to flow, an area where the organic EL element is formed (a light emission region) in each display pixel can be relatively increased, thereby improving a numerical aperture of the display panel.

Additionally, since the gate voltage of the double-gate type transistor can be set low in order to allow the same drain current to flow, the pixel drive circuit having excellent operating characteristics (i.e., the display panel having excellent display characteristics) can be realized while suppressing deterioration in transistor characteristics (the voltage-current characteristics), and power consumption involved by an image display operation can be suppressed.

Further, in the double-gate type transistor according to this structural example, even if the potential difference (the bias voltage) Vds between the source and drain terminals is relatively small, since the drain current Id tends to considerably increase, the drain current Id can be increased in a case where an operation is performed in a saturation operation region in which the bias voltage is large like the light emission drive transistor as well as a case where an operation is carried out in a linear operation region where the bias voltage is relatively small. Therefore, the double-gate type transistor according to this structural example can be excellently applied to a thin film transistor other than the light emission drive transistor, e.g., the thin film transistor Tr11 constituting the image drive circuit DCA or DCB, the thin film transistors Tr21 and Tr22 and others. A transistor size (a gate width) of each of these thin film transistors can be reduced, thereby further improving a numerical aperture of the display panel.

It is to be noted that each of the foregoing embodiments has the configuration in which the top gate terminal and the bottom gate terminal are short-circuited in the double-gate type transistor which allows a driving current to flow to the optical element in the pixel drive circuit. However, the present invention is not restricted thereto, and a voltage different from that of the bottom gate terminal may be applied to the top gate terminal, for example. In this case, for example, when a voltage higher than that of the bottom gate terminal is applied to the top gate terminal, the voltage-current characteristics (the drain current with respect to the gate voltage) can be further improved to allow a larger driving current to flow with the same gate voltage as compared with a case where the top gate terminal and the bottom gate terminal are short-circuited. Moreover, an element size of a switching element which allows the same driving current to flow can be further reduced.

What is claimed is:

1. A drive circuit which drives an optical element in accordance with a gradation signal corresponding to display data, comprising at least:
an electric charge holding circuit which holds electric charges based on the gradation signal as a voltage component; and
a driving current control circuit which generates a driving current based on the voltage component held in the electric charge holding circuit and supplies the generated driving current to the optical element,
wherein the driving current control circuit has at least one double-gate type thin film transistor including a semiconductor layer, a first gate electrode provided above the semiconductor layer, a second gate electrode provided below the semiconductor layer, and a source electrode and a drain electrode provided on both end portion sides of the semiconductor layer.

2. The drive circuit according to claim 1, wherein the gradation signal is a signal current having a current value corresponding to the display data.

3. The drive circuit according to claim 1, wherein the gradation signal is a signal voltage having a voltage value corresponding to the display data.

4. The drive circuit according to claim 1, wherein the first gate electrode and the second gate electrode in the double-gate type thin film transistor are electrically connected with each other.

5. The drive circuit according to claim 1, wherein the electric charge holding circuit has at least two capacitance components which hold the electric charges, and are formed when one of the source electrode and the drain electrode faces the first gate electrode and the second gate electrode.

6. The drive circuit according to claim 1, wherein the optical element has a current control type light emission element which operates to emit light with a luminance gradation in accordance with a current value of the driving current.

7. The drive circuit according to claim 6, wherein the light emission element has an organic electroluminescent element.

8. The drive circuit according to claim 1, wherein the semiconductor layer in the double-gate type thin film transistor is formed of amorphous silicon.

9. The drive circuit according to claim 1, wherein, in the double-gate type thin film transistor the source electrode and the drain electrode extend on the semiconductor layer in such a manner that they partially overlap the semiconductor layer.

10. The drive circuit according to claim 9, wherein an insulating film is provided between a part of the source electrode and a part of the drain electrode which extend on the semiconductor layer.

11. The drive circuit according to claim 9, wherein the first gate electrode is provided in a region between the source electrode and the drain electrode on the semiconductor layer.

12. The drive circuit according to claim 9, wherein overlap dimensions of the source electrode and the drain electrode on the semiconductor layer are equal to each other.

13. The drive circuit according to claim 9, wherein overlap dimensions of the source electrode and the drain electrode on the semiconductor layer are different from each other.

14. The drive circuit according to claim 13, wherein one of the source electrode and the drain electrode is electrically connected with the optical element, and
the overlap dimension of one of the source electrode and the drain electrode, which is connected with the optical element, on the semiconductor layer is shorter than the overlap dimension of the other electrode on the semiconductor layer.

15. The drive circuit according to claim 1, further comprising a gradation signal control circuit which controls a timing at which the gradation signal is supplied to the electric charge holding circuit.

16. The drive circuit according to claim 15, wherein the gradation signal control circuit has at least one thin film transistor including a single gate electrode.

17. The drive circuit according to claim 15, wherein the gradation signal control circuit has at least one double-gate type thin film transistor.

18. A display apparatus which displays image information according to a gradation signal corresponding to display data, comprising at least a display panel which has, a plurality of scanning lines and a plurality of signal lines arranged to be orthogonal to each other, and a plurality of display pixels arranged in the vicinity of respective intersections of the respective scanning lines and signal lines,
wherein each of the display pixel includes an optical element and a drive circuit which comprises at least: an electric charge holding circuit which holds electric charges based on the gradation signal as a voltage component, and a driving current control circuit which generates a driving current based on the voltage component held in the electric charge holding circuit and supplies the generated driving current to the optical element, thereby controlling an operation of the optical element, and
the driving current control circuit has at least one double-gate type thin film transistor including a semiconductor layer, a first gate electrode provided above the semiconductor layer, a second gate electrode provided below the semiconductor layer, and source and drain electrodes provided on both end portion sides of the semiconductor layer.

19. The display apparatus according to claim 18, further comprising:
a scanning drive circuit which sequentially applies a selection signal to each of the plurality of scanning lines in the display panel to set a selection state in which the gradation signal is written in the display pixel corresponding to each scanning line; and
a signal drive circuit which generates the gradation signal corresponding to the display pixel set to the selection state in accordance with the display data and supplies the generated gradation signal to the plurality of signal lines.

20. The display apparatus according to claim 18, wherein the gradation signal is a signal current having a current value corresponding to the display data.

21. The display apparatus according to claim 18, wherein the gradation signal is a signal voltage having a voltage value corresponding to the display data.

22. The display apparatus according to claim 18, wherein the first gate electrode and the second gate electrode in the double-gate type thin film transistor are electrically connected with each other.

23. The display apparatus according to claim 18, wherein the electric charge holding circuit has a capacitance components which hold the electric charges, the capacitance components being formed when one of a part of the source electrode and a part of the drain electrode faces the first gate electrode and the second gate electrode.

24. The display apparatus according to claim 18, wherein the optical element has a current control type light emission element which operates to emit light with a luminance gradation in accordance with a current value of the driving current.

25. The display apparatus according to claim 24, wherein the light emission element is an organic electroluminescent element.

26. The display apparatus according to claim 18, wherein the semiconductor layer in the double-gate type thin film transistor is formed of amorphous silicon.

27. The display apparatus according to claim 18, wherein the source electrode and the drain electrode in the double-gate type thin film transistor extend on the semiconductor layer in such a manner that they partially overlap the semiconductor layer.

28. The display apparatus according to claim 27, wherein an insulating film is provided between the source electrode and the drain electrode extending on the semiconductor layer and the semiconductor layer.

29. The display apparatus according to claim 27, wherein the first gate electrode is provided in a region between the source electrode and the drain electrode on the semiconductor layer.

30. The display apparatus according to claim 27, wherein overlap dimensions of the source electrode and the drain electrode on the semiconductor layer are equal to each other.

31. The display apparatus according to claim 27, wherein overlap dimensions of the source electrode and the drain electrode on the semiconductor layer are different from each other.

32. The display apparatus according to claim 31, wherein one of the source electrode and the drain electrode is electrically connected with the optical element, and
the overlap dimension of one of a part of the source electrode and a part of the drain electrode, which is electrically connected with the optical element, on the semiconductor layer is shorter than the overlap dimension of the other electrode on the semiconductor layer.

33. The display apparatus according to claim 18, wherein the drive circuit further comprises a gradation signal control circuit which controls a timing at which the gradation signal is supplied to the electric charge holding circuit.

34. The display apparatus according to claim 33, wherein the gradation signal control circuit has at least one thin film transistor including a single gate electrode.

35. The display apparatus according to claim 33, wherein the gradation signal control circuit has at least one double-gate type thin film transistor.
